(19) United States
(12) Patent Application Publication
(10) Pub. No.: US 2014/0213716 A1
(43) Pub. Date: Jul. 31, 2014

(54) PRESSURE-SENSITIVE ADHESIVE COMPOSITION AND PRESSURE-SENSITIVE ADHESIVE SHEET

(71) Applicant: NITTO DENKO CORPORATION, Osaka (JP)

(72) Inventors: Yoshihiro OKADA, Osaka (JP); Naoyuki Nishiyama, Osaka (JP); Hironao Ootake, Osaka (JP); Naoki Nakayama, Osaka (JP); Junichi Nakayama, Osaka (JP)

(73) Assignee: NITTO DENKO CORPORATION, Osaka (JP)

(21) Appl. No.: 14/169,458

(22) Filed: Jan. 31, 2014

(30) Foreign Application Priority Data
Jan. 31, 2013 (JP) 2013-017842
Jun. 28, 2013 (JP) 2013-136881

(51) Int. Cl. C09J 153/02; C09J 193/00; C09J 171/00

(52) U.S. Cl. CPC C09J 153/02; C09J 171/00; C09J 193/00
USPC 524/502; 524/575; 525/186

(57) ABSTRACT

This invention provides a PSA composition comprising a base polymer and a tackifier resin. The base polymer is a block copolymer of a monovinyl-substituted aromatic compound and a conjugated diene compound. The tackifier resin comprises a tackifier resin T_{H} having a softening point of 120° C. or above. The tackifier resin T_{H} comprises a tackifier resin T_{HR1} having an aromatic ring while having a hydroxyl value of 30 mgKOH/g or lower.

### CROSS-REFERENCE

The present application claims priority based on Japanese Patent Application No. 2013-017842 filed on Jan. 31, 2013 and Japanese Patent Application No. 2013-136881 filed on Jun. 28, 2013, and the entire contents of these applications are incorporated herein by reference.

### BACKGROUND OF THE INVENTION

1. Field of the Invention

The present invention relates to a pressure-sensitive adhesive composition comprising, as a base polymer, a block copolymer (e.g., a styrene-based block copolymer) of a monovinyl-substituted aromatic compound and a conjugated diene compound. The present invention also relates to a pressure-sensitive adhesive sheet that comprises a pressure-sensitive adhesive comprising such a copolymer as a base polymer.

2. Description of the Related Art

In general, pressure-sensitive adhesive (PSA) exists as a soft solid (a viscoelastic material) in a room temperature range and has a property to adhere easily to an adherend with some pressure applied. Taking advantage of such a property, PSA has been widely used as a means of attachment that works efficiently and produces dependable adhesion in various industrial fields from home appliances to automobiles, OA equipment, and so on. A typical composition of PSA comprises a base polymer and a tackifier resin. As the base polymer, a polymer that exhibits rubber elasticity at room temperature can be preferably used. For example, Japanese Patent Application Publication No. 2001-123140, Japanese Patent Application Publication No. 2001-342441 and Japanese Patent Application Publication No. H10-287858 disclose a PSA comprising a styrene-based block copolymer such as a styrene-isoprene-styrene block copolymer, a styrene-butadiene-styrene block copolymer, or the like.

### SUMMARY OF THE INVENTION

A PSA comprising a block copolymer (e.g. a styrene-based block copolymer) of a monovinyl-substituted aromatic compound and a conjugated diene compound as a base polymer generally exhibits significantly weaker cohesive strength at higher temperatures as compared to its cohesive strength at ambient temperature. It will be useful if the PSA comprising the block copolymer as the base polymer can be made to have improved high temperature cohesive strength.

One objective of the present invention is to provide a PSA composition that comprises a block copolymer (e.g. a styrene-based block copolymer) of a monovinyl-substituted aromatic compound and a conjugated diene compound as a based polymer and can form a PSA having improved cohesive strength under a high temperature environment (high temperature cohesive strength). Another related objective is to provide a PSA sheet comprising a PSA formed from such a PSA composition.

A PSA composition disclosed by this description comprises a base polymer and a tackifier resin. The base polymer is a block copolymer of a monovinyl-substituted aromatic compound and a conjugated diene compound. The tackifier resin comprises a tackifier resin T_{H} having a softening point of 120° C. or above. The tackifier resin T_{H} comprises a tackifier resin T_{HR1} having an aromatic ring while having a hydroxyl value of 30 mgKOH/g or lower. According to a PSA composition having such a composition, a PSA sheet exhibiting improved high temperature cohesive strength can be obtained.

In a preferable embodiment, the tackifier resin T_{HR1} can be selected from coumarone-indene resins, aromatic petroleum resins, aliphatic/aromatic copolymer-based petroleum resins and styrene-based resins. According to such an embodiment, a PSA sheet exhibiting greater high temperature cohesive strength can be obtained.

Another PSA composition disclosed by this description comprises a base polymer and a tackifier resin. The base polymer is a block copolymer of a monovinyl-substituted aromatic compound and a conjugated diene compound. The tackifier resin comprises a tackifier resin T_{H} having a softening point of 120° C. or above. The tackifier resin T_{H} comprises a tackifier resin T_{HR2} having an aromatic ring, but essentially free of isoprene units, terpene structures and rosin structures. According to a PSA composition having such a composition, a PSA sheet exhibiting improved high temperature cohesive strength can be obtained.

The tackifier resin T_{HR2} can be selected from coumarone-indene resins, aromatic petroleum resins, aliphatic/aromatic copolymer-based petroleum resins and styrene-based resins. According to such an embodiment, a PSA sheet exhibiting greater high temperature cohesive strength can be obtained.

The PSA compositions disclosed herein can be practiced preferably in an embodiment wherein the tackifier resin further comprises a tackifier resin T_{L} having a softening point below 120° C. According to such an embodiment, a PSA sheet combining great high temperature cohesive strength and high adhesiveness can be obtained.

The base polymer preferably has a diblock fraction of 60% by mass or greater. By this means, a PSA sheet combining great high temperature cohesive strength and high adhesiveness can be obtained.

As the base polymer, can be preferably used a styrene-based block copolymer (styrene-isoprene-styrene block copolymer, styrene-butadiene-styrene block copolymer, etc.). For example, a styrene-based block copolymer having a 20% by mass or lower styrene content is preferable. According to a PSA composition comprising such a styrene-based block copolymer as a base polymer, a PSA sheet combining great high temperature cohesive strength and high adhesiveness can be obtained.

The tackifier resin T_{HR1} content is preferably in a range of 0.1 to 10 parts by mass relative to 1 part by mass of styrene in the styrene-based block copolymer. By this means, a PSA sheet of higher performance can be obtained. The same applies also to the tackifier resin T content.

In the PSA compositions disclosed herein, a preferable base polymer has a diblock fraction of 60% by mass or greater. According to a PSA composition comprising such a base polymer, a PSA sheet of higher performance can be obtained.

The PSA composition according to a preferable embodiment further comprises conductive particles. The PSA composition comprising such conductive particles allows formation of a conductive PSA sheet that exhibits excellent adhesive properties (e.g. adhesive strength). While the conductive particle content is not particularly limited, it is preferably 0.01 part by mass to 100 parts by mass relative to 100 parts by mass of all non-volatiles in the PSA composition excluding the conductive particles.

This description also provides a PSA sheet comprising a PSA formed from a PSA composition disclosed herein. According to such a PSA sheet, in an embodiment comprising a PSA that comprises as a base polymer a block copolymer of a monovinyl-substituted aromatic compound and a conjugated diene compound, great high temperature cohesive strength can be exhibited.

### BRIEF DESCRIPTION OF THE DRAWINGS

FIG. 1 shows a cross-sectional view schematically illustrating the constitution of a PSA sheet according to an embodiment (a substrate-containing double-faced PSA sheet).

FIG. 2 shows a cross-sectional view schematically illustrating the constitution of a PSA sheet according to another embodiment (a substrate-free double-faced PSA sheet).

FIG. 3 shows a cross-sectional view schematically illustrating the constitution of a PSA sheet according to another embodiment (a substrate-containing single-faced PSA sheet).

FIG. 4 shows a diagram illustrating a method for testing the repulsion resistance.

FIG. 5 shows a diagram illustrating a method for measuring the resistance.

### DETAILED DESCRIPTION OF THE INVENTION

Preferred embodiments of the present invention are described below. Matters necessary to practice this invention other than those specifically referred to in this description may be understood as design matters based on the conventional art in the pertinent field for a person of ordinary skill in the art. The present invention can be practiced based on the contents disclosed in this description and common technical knowledge in the subject field.

In the drawings referenced below, a common reference numeral is assigned to members or sites producing the same effects, and duplicated descriptions are sometimes omitted or simplified. The embodiments described in the drawings are schematized for clear illustration of the present invention, and do not represent the accurate sizes or reduction scales of the PSA sheet to be provided as an actual product by the present invention.

As used herein, the term “PSA” refers to, as described earlier, a material that exists as a soft solid (a viscoelastic material) in a room temperature range and has a property to adhere easily to an adherend with some pressure applied. As defined in “Adhesion: Fundamental and Practice” by C. A. Dahlquist (McLaren & Sons (1966), P. 143), PSA referred to herein is a material that has a property satisfying complex tensile modulus E*(1 Hz)<10⁷ dyne/cm² (typically, a material that exhibits the described characteristics at 25° C.). The PSA in the art disclosed herein can be considered as non-volatiles in a PSA composition or the constituent of a PSA layer.

The “base polymer” of a PSA refers to the primary component among rubbery polymers (polymers that exhibit rubber elasticity in a room temperature range) contained in the PSA, that is, a component accounting for 50% by mass or more of all rubbery polymers.

As used herein, “block copolymer of a monovinyl-substituted aromatic compound and a conjugated diene compound” refers to a polymer comprising at least one each of a segment (segment A) that comprises a monovinyl-substituted aromatic compound as a primary monomer (which refers to a copolymer component accounting for more than 50% by mass; the same applies hereinafter) and a segment (segment B) that comprises a conjugated diene compound as a primary monomer, with the primary monomer being a copolymer component accounting for more than 50% by mass (the same applies hereinafter). In general, the glass transition temperature of segment A is higher than that of segment B. Examples of a typical constitution of such a polymer include an ABA triblock copolymer having a triblock structure where segment B (soft segment) is coupled to segment A (hard segment) at each terminal, an AB diblock copolymer having a diblock structure comprising one segment A and one segment B, and the like.

As used herein, “styrene-based block copolymer” refers to a polymer comprising at least one styrene block. The “styrene block” refers to a segment comprising styrene as a primary monomer. A typical example of a styrene block referred to herein is a segment consisting essentially of styrene. “Styrene-isoprene block copolymer” refers to a polymer comprising at least one styrene block and at least one isoprene block (a segment comprising isoprene as a primary monomer). Typical examples of a styrene-isoprene block copolymer include a triblock copolymer having a triblock structure where an isoprene block (soft segment) is coupled to a styrene block (hard segment) at each terminal, a diblock copolymer having a diblock structure comprising one isoprene block and one styrene block, and the like. “Styrene-butadiene block copolymer” refers to a polymer comprising at least one styrene block and at least one butadiene block (a segment comprising butadiene as a primary monomer).

As used herein, “the styrene content” in a styrene-based block copolymer refers to the mass fraction of styrene residue contained in the total mass of the block copolymer. The styrene content can be measured by NMR (nuclear magnetic resonance spectroscopy).

The diblock content (which hereinafter may be referred to as the “diblock fraction” or “diblock ratio”) in a styrene-based block copolymer can be determined by the following method. That is, a given styrene-based block copolymer is dissolved in tetrahydrofuran (THF) and subjected to high-performance liquid chromatography at a temperature of 40° C. with the THF as the mobile phase passing at a flow rate of 1 mL/min through four linearly connected columns consisting of two each of liquid chromatography columns GS5000H and G4000H both available from Tosoh Corporation; from the resulting chromatogram, the area of the peak corresponding to the diblock copolymer is determined; and the diblock fraction is determined as the percentage of the area of the peak corresponding to the diblock relative to the total area of all peaks.

### <Base Polymer>

The PSA composition disclosed herein comprises as a base polymer a block copolymer of a monovinyl-substituted aromatic compound and a conjugated diene compound. The monovinyl-substituted aromatic compound refers to a compound in which a functional group containing a vinyl group is bonded to an aromatic ring. Typical examples of the aromatic ring include a benzene ring (which can be a benzene ring substituted with a functional group (e.g., an alkyl group) containing no vinyl groups). Examples of the monovinyl-substituted aromatic compound include styrene, α-methyl styrene, vinyl toluene, vinyl xylene, and the like. Examples of the conjugated diene compound include 1,3-butadiene, isoprene, and the like. Among such block copolymers, one species can be used solely, or two or more species can be used together as the base polymer.

Segment A (hard segment) in the block copolymer comprises the monovinyl-substituted aromatic compound (for which, two or more species can be used together) at a copolymerization ratio of preferably 70% by mass or greater (more preferably 90% by mass or greater, or it can be essentially 100% by mass). Segment B (soft segment) in the block copolymer comprises the conjugated diene compound (for which, two or more species can be used) at a copolymerization ratio of preferably 70% by mass or greater (more preferably 90% by mass or greater, or it can be essentially 100% by mass). According to such a block copolymer, a PSA sheet of higher performance can be obtained.

The block copolymer may be a diblock copolymer, a triblock copolymer, a radial copolymer, a mixture of these, or the like. In a triblock copolymer or a radial copolymer, it is preferable that segment A (e.g., a styrene block) is placed at a terminal of the polymer chain. Segment A placed terminally on the polymer chain is likely to aggregate to form a domain, whereby pseudo crosslinks are formed, resulting in increased cohesive strength of the PSA.

In the art disclosed herein, from the standpoint of the adhesive strength (peel strength) to an adherend, a preferable block copolymer has a diblock fraction of 30% by mass or greater (more preferably 40% by mass or greater, even more preferably 50% by mass or greater, or especially preferably 60% by mass or greater, typically 65% by mass or greater). From the standpoint of the peel strength, a particularly preferable block copolymer has a diblock fraction of 70% by mass or greater. From the stand point of the cohesive strength, etc., can be used a block copolymer having a diblock fraction of preferably 90% by mass or smaller (more preferably 85% by mass or smaller, e.g. 80% by mass or smaller). For instance, a preferable block copolymer has a diblock fraction of 60 to 85% by mass, or more preferably 70 to 85% by mass (e.g. 70 to 80% by mass).

### <Styrene-Based Block Copolymer>

In a preferable embodiment of the art disclosed herein, the base polymer is a styrene-based block copolymer. For instance, an embodiment wherein the base polymer comprises at least one of a styrene-isoprene block copolymer and a styrene-butadiene block copolymer is preferable. It is preferable that the styrene-based block copolymer contained in the PSA comprises either a styrene-isoprene block copolymer at a ratio of 70% by mass or greater, a styrene-butadiene block copolymer at a ratio of 70% by mass or greater, or a styrene-isoprene block copolymer and a styrene-butadiene block copolymer at a combined ratio of 70% by mass or greater. In a preferable embodiment, essentially all (e.g., 95 to 100% by mass) of the styrene-based block copolymer is a styrene-isoprene block copolymer. In another preferable embodiment, essentially all (e.g., 95 to 100% by mass) of the styrene-based block copolymer is a styrene-butadiene block copolymer. According to such compositions, greater effects may be obtained by applying the art disclosed herein.

The styrene-based block copolymer can be a diblock copolymer, a triblock copolymer, a radial copolymer, a mixture of these, or the like. In a triblock copolymer and a radial copolymer, it is preferable that a styrene block is placed at a terminal of the polymer chain. The styrene block placed terminally on the polymer chain is likely to aggregate to form a styrene domain, whereby pseudo crosslinks are formed, resulting in increased cohesive strength of the PSA. In the art disclosed herein, from the standpoint of the adhesive strength (peel strength) to an adherend, a preferable styrene-based block copolymer has a diblock fraction of 30% by mass or greater (more preferably 40% by mass or greater, even more preferably 50% by mass or greater, or especially preferably 60% by mass or greater, typically 65% by mass or greater). The styrene-based block copolymer may have a diblock fraction of 70% by mass or greater (e.g., 75% by mass or greater). From the standpoint of the cohesive strength, etc., a preferable styrene-based block copolymer has a diblock fraction of 90% by mass or smaller (more preferably 85% by mass or smaller, e.g. 80% by mass or smaller). From the standpoint of combining high temperature cohesive strength and other properties (e.g. peel strength) at a good balance by applying the art disclosed herein, the styrene-based block copolymer has a diblock fraction of preferably 60 to 85% by mass or more preferably 70 to 85% by mass (e.g. 70 to 80% by mass).

The styrene content in the styrene-based block copolymer can be, for instance, 5 to 40% by mass. From the standpoint of the cohesive strength, in usual, it is preferable that the styrene content is 10% by mass or greater (more preferably greater than 10% by mass, e.g., 12% by mass or greater). From the standpoint of the peel strength, the styrene content is preferably 35% by mass or less (typically 30% by mass or less, or more preferably 25% by mass or less) or particularly preferably 20% by mass or less (typically, less than 20% by mass, e.g. 18% by mass or less). From the standpoint of obtaining greater effects by applying the art disclosed herein (e.g. the effect of increasing the high temperature cohesive strength), can be preferably used a styrene-based block copolymer having a styrene content of 12% by mass or greater, but less than 20% by mass.

### <Tackifier Resin>

The PSA composition disclosed herein comprises a tackifier resin in addition to the base polymer. As the tackifier resin, can be used one, two or more species selected from various known tackifier resins such as petroleum resins, styrene-based resins, coumarone-indene resins, terpene resins, modified terpene resins, rosin-based resins, rosin-derivative resins, ketone-based resins, and the like.

Examples of petroleum resins include aliphatic (C5-based) petroleum resins, aromatic (C9-based) petroleum resins, aliphatic/aromatic copolymer (C5/C9-based) petroleum resins, hydrogenated products of these (e.g. alicyclic petroleum resins obtainable by hydrogenating aromatic petroleum resins) and the like.

Examples of styrene-based resins include a resin comprising a styrene homopolymer as a primary component, a resin comprising an α-methylstyrene homopolymer as a primary component, a resin comprising a vinyltoluene homopolymer as a primary component, a resin comprising as a primary component a copolymer having a monomer composition that includes two or more species among styrene, α-methylstyrene and vinyltoluene (e.g. an α-methylstyrene/styrene copolymer resin comprising an α-methylstyrene/styrene copolymer as a primary component) and the like.

As a coumarone-indene resin, can be used a resin comprising coumarone and indene as monomers constituting the backbone (main chain) of the resin. Examples of monomers that can be contained in the resin backbone other than coumarone and indene, include styrene, α-methylstyrene, methylindene, vinyltoluene and the like.

Examples of terpene resins include poly-α-pinene, poly-β-pinene, poly-dipentene, etc. Examples of modified terpene resins include those obtainable from these terpene resins via modifications (phenol modification, styrene modification, hydrogenation, hydrocarbon modification, or the like). Specific examples include terpene phenol resins, styrene-modified terpene resins, hydrogenated terpene resins, and the like.

The “terpene phenol resin” refers to a polymer containing terpene residue and phenol residue, and the scope thereof encompasses both a terpene phenol copolymer resin and a phenol-modified terpene resin, with the former being a copolymer of a terpene and a phenolic compound, and the latter being a phenol-modification product of a terpene homopolymer or a terpene copolymer (a terpene resin, typically an unmodified terpene resin). Preferable examples of a terpene constituting the terpene phenol resin include mono-terpenes such as α-pinene, β-pinene, limonene (including d-limonene, l-limonene, and d/l-limonene (dipentene)), and the like.

Examples of rosin-based resins include unmodified rosins (raw rosins) such as gum rosin, wood rosin, tall-oil rosin, etc.; modified rosins obtainable from these unmodified rosins via a modification such as hydrogenation, disproportionation, polymerization, etc. (hydrogenated rosins, disproportionated rosins, polymerized rosins, other chemically-modified rosins, etc.); and the like. Examples of rosin-derived resins include rosin esters such as unmodified rosins esterified with alcohols (i.e., esterification products of unmodified rosins) and modified rosins (hydrogenated rosins, disproportionated rosins, polymerized rosins, etc.) esterified with alcohols (i.e., esterification products of modified rosins), and the like; unsaturated fatty-acid-modified rosins obtainable from unmodified rosins and modified rosins (hydrogenated rosin, disproportionated rosin, polymerized rosin, etc.) via modifications with unsaturated fatty acids; unsaturated fatty-acid-modified rosin esters obtainable from rosin esters via modifications with unsaturated fatty acids; rosin alcohols obtainable via reduction of carboxyl groups from unmodified rosins, modified rosins (hydrogenated rosins, disproportionated rosins, polymerized rosin, etc.), unsaturated fatty-acid-modified rosins or unsaturated fatty-acid-modified rosin esters; metal salts of rosins including unmodified rosins, modified rosins, various rosin derivatives, etc. (in particular, metal salts of rosin esters); rosin phenol resins obtainable from rosins (unmodified rosins, modified rosins, various rosin derivatives, etc.) via addition of phenol in the presence of an acid catalyst followed by thermal polymerization; and so on.

The composition disclosed herein comprises a tackifier resin T_{H} having a softening point of 120° C. or above as the tackifier resin. From the standpoint of the high temperature cohesive strength, the softening point of tackifier resin T_{H} is preferably 125° C. or above, more preferably 130° C. or above, or even more preferably 135° C. or above (e.g. 140° C. or above). From the standpoint of the peel strength to an adherend, etc., in usual, the softening point of tackifier resin T_{H} is suitably 200° C. or below, preferably 180° C. or below, or more preferably 170° C. or below (e.g. 160° C. or below).

The softening point of a tackifier resin referred to herein is defined as a value measured based on the softening point test method (ring and ball method) specified in JIS K5902 and JIS K2207. In particular, a sample is quickly melted at a lowest possible temperature, and with caution to avoid bubble formation, the melted sample is poured into a ring to the top, with the ring being placed on top of a flat metal plate. After cooled, any portion of the sample risen above the plane including the upper rim of the ring is sliced off with a small knife that has been somewhat heated. Following this, a support (ring support) is placed in a glass container (heating bath) having a diameter of 85 mm or larger and a height of 127 mm or larger, and glycerin is poured into this to a depth of 90 mm or deeper. Then, a steel ball (9.5 mm diameter, weighing 3.5 g) and the ring filled with the sample are immersed in the glycerin while preventing them from touching each other, and the temperature of glycerin is maintained at 20° C.±5° C. for 15 minutes. The steel ball is then placed at the center of the surface of the sample in the ring, and this is placed on a prescribed location of the support. While keeping the distance between the ring top and the glycerin surface at 50 mm, a thermometer is placed so that the center of the mercury ball of the thermometer is as high as the center of the ring, and the container is heated evenly by projecting a Bunsen burner flame at the midpoint between the center and the rim of the bottom of the container. After the temperature has reached 40° C. from the start of heating, the rate of the bath temperature rise must be kept at 5° C.±0.5° C. per minute. As the sample gradually softens, the temperature at which the sample flows out of the ring and finally touches the bottom plate is read as the softening point. Two or more measurements of softening point are performed at the same time, and their average value is used.

### <Tackifier Resin T_{HR1}>

In a preferable embodiment of the art disclosed herein, the tackifier resin T_{H} may comprise a tackifier resin T_{HR1} having an aromatic ring while having a hydroxyl value of 30 mgKOH/g or lower. This can effectively improve the high temperature cohesive strength. For the tackifier resin T_{HR1}, solely one species or a combination of two or more species can be used.

The hydroxyl value of tackifier resin T_{HR1} is preferably lower than 10 mgKOH/g, more preferably lower than 5 mgKOH/g, or even more preferably lower than 3 mgKOH/g. For example, a preferable tackifier resin T_{HR1} has a hydroxyl value below 1 mgKOH/g or has no detectable hydroxyls.

Examples of a tackifier resin having an aromatic ring include the aromatic petroleum resins, aliphatic/aromatic copolymer-based petroleum resins, styrene-based resins, coumarone-indene resins, styrene-modified terpene resins, phenol-modified terpene resins, and rosin phenol resins described earlier, and the like. Among these, as the tackifier resin T_{HR1}, can be used a resin having a softening point of 120° C. or above (preferably 130° C. or above, e.g. 135° C. or above) while having a hydroxyl value of 30 mgKOH/g or lower (preferably lower than 5 mgKOH/g, e.g. lower than 1 mgKOH/g).

As the hydroxyl value, can be used a value measured by the potentiometric titration method specified in BS K0070:1992. Details of the method are described below. [Method for measuring hydroxyl value]

### 1. Reagents

(1) As the acetylation reagent, is used a solution prepared by mixing with sufficient stirring about 12.5 g (approximately 11.8 mL) of anhydrous acetic acid and pyridine added up to a total volume of 50 mL. Alternatively, is used a solution prepared by mixing with sufficient stirring about 25 g (approximately 23.5 mL) of anhydrous acetic acid and pyridine up to a total volume of 100 mL.
(2) As the titrant, is used a 0.5 mol/L potassium hydroxide (KOH) solution in ethanol.
(3) For others, toluene, pyridine, ethanol and distilled water should be ready for use.

### 2. Procedures

(1) Approximately 2 g of analyte is accurately weighed out in a flat-bottom flask, 5 mL of the acetylation reagent and 10 mL of pyridine are added, and an air condenser is placed on.
(2) The flask is heated in a bath at 100° C. for 70 minutes and then cooled. From the top of the condenser, 35 mL of toluene is added as a solvent and stirred. Subsequently, 1 mL of distilled water is added and the resultant is stirred to decompose any remaining anhydrous acetic acid. The flask is heated in the bath again for 10 minutes to complete the decomposition and then cooled.
(3) After rinsed with 5 mL of ethanol, the condenser is removed. Subsequently, 50 mL of pyridine is added as a solvent and the resultant is stirred.
(4) Using a volumetric pipette, is added 25 mL of the 0.5 mol/L KOH ethanol solution.
(5) Potentiometric titration is carried out with the 0.5 mol/L KOH ethanol solution. The inflection point in the resulting titration curve is taken as the final point.
(6) For a blank titration, procedures (1) to (5) are carried out without addition of the analyte.

### 3. Calculations

The hydroxyl value is calculated by the following equation:

Hydroxyl value (mgKOH/g)=[(B−C)×f×28.05]/S+D

wherein:

B is the volume (mL) of the 0.5 mol/L KOH ethanol solution used in the blank titration;

C is the volume (mL) of the 0.5 mol/L KOH ethanol solution used to titrate the analyte;

f is the factor of the 0.5 mol/L KOH ethanol solution;

S is the mass of analyte (g);

D is the acid value;

28.05 is one half the molecular weight of KOH.

Preferable examples of materials usable as the tackifier resin T_{HR1} include aromatic petroleum resins, aliphatic/aromatic copolymer-based petroleum resins, styrene-based resins and coumarone-indene resins. A preferable aliphatic/aromatic copolymer-based petroleum resin has a copolymerization ratio of C5 fractions below 15% by mass (more preferably below 10% by mass, even more preferably below 5% by mass, e.g. below 3% by mas). A preferable one has a copolymerization ratio of C9 fractions of 55% by mass or higher (more preferably 60% by mass or higher, even more preferably 65% by mass or higher).

Particularly preferable tackifier resins T_{HR1} include aromatic petroleum resins and styrene-based resins (e.g. α-methylstyrene/styrene copolymer resin).

While to practice the art disclosed herein, it is unnecessary to reveal how the use of tackifier resin T_{HR1} improves the high temperature cohesive strength, the following can be considered, for example. That is, the tackifier resin T_{HR1} having an aromatic ring is likely to be compatible with a domain (or a “hard domain” hereinafter, e.g. a styrene domain in a styrene-based block copolymer) formed with aggregated hard segments comprising a monovinyl-substituted aromatic compound as a primary monomer. With a tackifier resin T_{HR1} having a high softening point blending with a hard domain, the heat resistance of pseudo crosslinks by the hard domain may increase. This is considered to contribute to improve the high temperature cohesive strength of the PSA.

It is noted here that, as a general tendency, a tackifier resin T_{H} having a high softening point is less compatible than a tackifier resin T_{L} having a low softening point. Thus, even with it having an aromatic ring, a tackifier resin T_{H} having a high hydroxyl value will blend only in a small amount with a hard domain or will be likely to undergo micro-scale phase separation in the hard domain to disturb the uniformity within the hard domain, making it difficult to suitably produce the effect of increasing the high temperature cohesive strength. This is more notable in a composition where the hard segment content in the base polymer (e.g. the styrene content in a styrene-based block copolymer) is relatively low.

It is considered that despite of having a high softening point, the tackifier resin T_{HR1} in the art disclosed herein has a hydroxyl value limited to 30 mgKOH/g or below; and therefore, it suitably blends with a hard domain even in a composition having a relatively low hard segment content (e.g. a styrene-based copolymer having a 20% by mass or lower styrene content), whereby the high temperature cohesive strength is effectively improved.

The amount of tackifier resin T_{HR1} used is not particularly limited and it can be suitably selected according to the purpose or intended use of the PSA composition. From the standpoint of the high temperature cohesive strength, in usual, the amount of tackifier resin T_{HR1} used relative to 100 parts by mass of the base polymer is preferably 5 parts by mass or greater, or more preferably 10 parts by mass or greater. From the standpoint of combining high temperature cohesive strength and peel strength at a high level, the amount of tackifier resin T_{HR1} used relative to 100 parts by mass of the base polymer can be, for instance, 100 parts by mass or less while it is usually preferable to be 80 parts by mass or less (e.g. 60 parts by mass or less). In view of the adhesive properties (e.g. peel strength) at low temperatures, the amount of tackifier resin T_{HR1} used relative to 100 parts by mass of the base polymer is preferably 40 parts by mass or less, or more preferably 30 parts by mass or less (e.g. 25 parts by mass or less).

Although not particularly limited, in an embodiment wherein the base polymer is a styrene-based block copolymer, the amount of tackifier resin T_{HR1} used relative to 1 part by mass of styrene in the block copolymer can be, for instance, 0.1 part by mass or greater. From the standpoint of the high temperature cohesive strength, it is preferably 0.2 part by mass or greater, or more preferably 0.5 part by mass or greater. The amount of tackifier resin T_{HR1} used relative to 1 part by mass of styrene in the block copolymer can be, for instance, 10 parts by mass or less. From the standpoint of combining high temperature cohesive strength and peel strength at a high level, it is preferably 7 parts by mass or less, or more preferably 5 parts by mass or less.

<Tackifier resin T_{HR2}>

In a preferable embodiment of the PSA composition disclosed herein, the tackifier resin T_{H} comprises a tackifier resin T_{HR2} having an aromatic ring, but essentially free of isoprene units, terpene structures and rosin structures. This can effectively improve the high temperature cohesive strength. For the tackifier resin T_{HR2}, solely one species or a combination of two or more species can be used.

Herein, the tackifier resin T_{HR2} being essentially free of isoprene units, terpene structures and rosin structures refers to that the combined ratio of these structural moieties (i.e. isoprene units, terpene structures and rosin structures) in the tackifier resin T_{HR2} is below 10% by mass (more preferably below 8% by mass, more preferably below 5% by mass, e.g. below 3% by mass). The ratio can be zero % by mass. The isoprene unit content, terpene structure content and rosin structure content in the tackifier resin T_{HR2} can be measured, for instance, by NMR (nuclear magnetic resonance spectrometry).

Examples of a tackifier resin having an aromatic ring, but essentially free of isoprene units, terpene structures and rosin structures include the aromatic petroleum resins, aliphatic/aromatic copolymer-based petroleum resins, styrene-based resins, coumarone-indene resins described above and the like. Among these, one having a softening point of 120° C. or above (preferably 130° C. or above; e.g. 135° C. or above) can be used as the tackifier resin T.

Particularly preferable tackifier resins T_{HR2} include aromatic petroleum resins and styrene-based resins (e.g. α-methylstyrene/styrene copolymer resin).

The tackifier resin T has an aromatic ring that can readily blend with a hard domain (e.g. styrene domain) in a block copolymer of a monovinyl-substituted aromatic compound and a conjugated diene compound (e.g. in a styrene-based block copolymer), but it is essentially free of isoprene units, terpene structure and rosin structures which are highly compatible with a soft segment (a segment comprising a conjugated diene compound as a primary monomer). Thus, a tackifier resin T included in a PSA comprising the block copolymer as a base polymer is locally distributed (blended) in the hard domain, whereby the heat resistance of pseudo crosslinks by the hard domain can be efficiently increased. Being essentially free of isoprene units, terpene structures and rosin structures, it may avoid or suppress unfavorable effects (reduced peel strength, reduced effect of increasing the high temperature cohesive strength due to an insufficient amount blending with the hard domain, etc.) caused by the tackifier resin T with a high softening point blending with soft segments to an excessive extent. By this means, a PSA sheet combining high temperature cohesive strength and peel strength at a high level can be obtained.

The amount of tackifier resin T used is not particularly limited and it can be suitably selected according to the purpose or intended use of the PSA composition. From the standpoint of the high temperature cohesive strength, in usual, the amount of tackifier resin T used relative to 100 parts by mass of the base polymer is preferably 5 parts by mass or greater, or more preferably 10 parts by mass or greater. From the standpoint of combining high temperature cohesive strength and peel strength at a high level, the amount of tackifier resin T used relative to 100 parts by mass of the base polymer can be, for instance, 100 parts by mass or less while it is usually preferable to be 80 parts by mass or less (e.g. 60 parts by mass or less). From the standpoint of the adhesive properties (e.g. peel strength) at low temperatures, the amount of tackifier resin T used relative to 100 parts by mass of the base polymer is preferably 40 parts by mass or less, or more preferably 30 parts by mass or less (e.g. 25 parts by mass or less).

Although not particularly limited, in an embodiment wherein the base polymer is a styrene-based block copolymer, the amount of tackifier resin T used relative to 1 part by mass of styrene in the block copolymer can be, for instance, 0.1 part by mass or greater. From the standpoint of the high temperature cohesive strength, it is preferably 0.2 part by mass or greater, or more preferably 0.5 part by mass or greater. The amount of tackifier resin T used relative to 1 part by mass of styrene in the block copolymer can be, for instance, 10 parts by mass or less. From the standpoint of combining high temperature cohesive strength and peel strength at a high level, it is preferably 7 parts by mass or less, or more preferably 5 parts by mass or less.

Although not particularly limited, for similar reasons as the tackifier resin T_{HR1}, a preferable tackifier resin T_{HR2} has a hydroxyl value of 30 mgKOH/g or lower (preferably below 5 mgKOH/g, e.g. below 1 mgKOH/g). Accordingly, as the tackifier resin T in the art disclosed herein, those that qualify as the tackifier resin T_{HR1} can be preferable used. Similarly, as the tackifier resin T_{HR1} in the art disclosed herein, those that qualify as the tackifier resin T_{HR2} can be preferably used.

The art disclosed herein is to improve the high temperature cohesive strength of a PSA by including a tackifier resin T_{HR1} and/or a tackifier resin T in a PSA composition comprising a block copolymer of a monovinyl-substituted aromatic compound and a conjugated diene compound as a base polymer. Thus, it can be preferably practiced in an embodiment using essentially a tackifier resin T_{HR1} and/or T_{HR2} alone as the tackifier resin. The problem of the present invention can be solved in such an embodiment as well.

On the other hand, according to the purpose or intended use, etc., the art disclosed herein can be preferably practiced also in an embodiment using a tackifier resin T_{HR1} and/or T_{HR2} as well as other tackifier resin(s) (or “optional tackifier resin(s)” hereinafter) together.

### <Tackifier Resin T_{L}>

A preferable example of an embodiment comprising optional tackifier resin(s) is an embodiment comprising a tackifier resin T_{L} having a softening point below 120° C. According to such an embodiment, for instance, a PSA sheet having greater peel strength can be obtained.

The lower limit of the softening point of tackifier resin T_{L} is not particularly limited. In usual, one having a softening point of 40° C. or above (typically 60° C. or above) can be preferably used. From the standpoint of combining high temperature cohesive strength and peel strength at a high level, in usual, a tackifier resin T_{L} having a softening point of 80° C. or above (more preferably 100° C. or above), but below 120° C. can be preferably used. In particular, it is preferable to use a tackifier resin T_{L} having a softening point of 110° C. or above, but below 120° C.

The hydroxyl value and the structure (e.g. the presence of an aromatic ring, presence of isoprene units, presence of terpene structures, presence of rosin structures, etc.) of tackifier resin T_{L} are not particularly limited. A suitable one can be selected and used among the various tackifier resins (petroleum resins, styrene-based resins, coumarone-indene resins, terpene resins, modified terpene resins, rosin-based resins, rosin-derivative resins, ketone-based resins, etc.) described earlier with them having a softening point below 120° C.

The art disclosed herein can be preferably practiced in an embodiment wherein the PSA comprises, as the tackifier resin T_{L}, at least one of a petroleum resin and a terpene resin. For instance, can be preferably employed a composition wherein the primary component (i.e., a component accounting for more than 50% by mass) of the tackifier resin T_{L} is a petroleum resin, a terpene resin, a combination of a petroleum resin and a terpene resin, or the like. From the standpoint of the adhesive strength and the compatibility, in a preferable embodiment, the primary component of the tackifier resin T_{L} is a terpene resin (e.g., poly-α-pinene and poly-β-pinene). Essentially all (e.g., 95% by mass or more) of the tackifier resin T_{L} can be a terpene resin.

<Tackifier resin T_{HO}>

Another preferable example of an embodiment comprising optional tackifier resin(s) is an embodiment comprising a tackifier resin T_{H} (which may be referred to as “tackifier resin T_{HO}” hereinafter) that does not qualify as either a tackifier resin T_{HR1} or a tackifier resin T. The use of tackifier resin T_{HO} may be useful in increasing properties such as repulsion resistance or peel property under a constant load, etc.)

As the tackifier resin T_{HO}, for example, can be used terpene phenol resins, rosin phenol resins, polymerized rosins, esterification products of polymerized rosins, etc. Among these tackifier resins T_{HO}, solely one species or a combination of two or more species can be used. In a preferable embodiment, one, two or more species of terpene phenol resin is used as the tackifier resin T_{HO}. For example, in a preferable embodiment, 25% by mass or greater (more preferably 30% by mass or greater) of the tackifier resin T_{HO} is a terpene phenol resin. 50% by mass or greater (more preferably 70% by mass or greater, even more preferably 80% by mass or greater, e.g. 90% by mass or greater) of the tackifier resin T_{HO} may be a terpene phenol resin, or essentially all (e.g. 95% by mass or greater) of the tackifier resin T_{HO} may be a terpene phenol resin. A preferable terpene phenol resin has a softening point of 120° C. or above, but 200° C. or below (typically 130° C. or above, but 180° C. or below; e.g. 135° C. or above, but 170° C. or below).

The art disclosed herein can be practiced preferably, for instance, in an embodiment comprising, as the tackifier resin T_{HO}, a tackifier resin (T_{HO1}) having a hydroxyl value of 80 mgKOH/g or higher (e.g. 90 mgKOH/g or higher). The hydroxyl value of tackifier resin T_{HO1} is typically 200 mgKOH/g or lower, or preferably 180 mgKOH/g or lower (e.g. 160 mgKOH/g or lower). For the hydroxyl value, can be used a value measured by the potentiometric titration method specified in JIS K0070:1992, specifically, a value determined by applying the method for measuring the hydroxyl value described earlier. According to a PSA comprising such a tackifier resin T_{HO1}, a PSA sheet of higher performance can be obtained. For example, it may be possible to obtain a PSA sheet combining high temperature cohesive strength and other properties (e.g. repulsion resistance, peel property under a constant load, etc.) at a higher level.

As the tackifier resin T_{HO1}, among the various tackifier resins listed earlier, can be used solely one species having a hydroxyl value equal to or higher than a prescribed value, or a few or more such species in a suitable combination. In a preferable embodiment, as the tackifier resin T_{HO1}, at least a terpene phenol resin is used. A terpene phenol resin is preferable because the hydroxyl value can be changed at will by modifying the copolymerization ratio of phenol. Preferably, 50% by mass or greater (more preferably 70% by mass or greater, e.g., 90% by mass or greater) of the tackifier resin T_{HO1} is a terpene phenol resin, or essentially all (e.g., 95 to 100% by mass, or even 99 to 100% by mass) thereof may be a terpene phenol resin.

The PSA composition disclosed herein may comprise a tackifier resin (T_{HO2}) having a hydroxyl value of zero or higher, but below 80 mgKOH/g as the tackifier resin T_{HO}. A tackifier resin T_{HO2} may be used as a substitute for a tackifier resin T_{HO1} or in a combination with a tackifier resin T_{HO1}. A preferable embodiment comprises a tackifier resin T_{HO1} having a hydroxyl value of 80 mgKOH/g or higher and a tackifier resin T_{HO2}. As the tackifier resin T_{HO2}, among the various tackifier resins listed earlier, can be used solely one species having a hydroxyl value in the cited range, or a few or more such species in a suitable combination. For example, can be used a terpene phenol resin, a petroleum resin (e.g., C5-based petroleum resins), a terpene resin (e.g., β-pinene polymers), a rosin-based resin (e.g., polymerized rosins), a rosin-derivative resin (e.g., esterification products of polymerized rosins), or the like, each having a hydroxyl value of zero or larger, but lower than 80 mgKOH/g.

The art disclosed herein can be practiced preferably in an embodiment wherein the PSA composition comprises a combination of a tackifier resin T_{HO1} having a hydroxyl value of 80 mgKOH/g or higher (typically 80 mgKOH/g to 160 mgKOH/g, e.g. 80 mgKOH/g to 140 mgKOH/g) and a tackifier resin T_{HO2} having a hydroxyl value of 40 mgKOH/g or higher, but lower than 80 mgKOH/g. In this case, the amounts of T_{HO1} and T_{HO2} used can be selected, for instance, to have a mass ratio (T_{HO1}:T_{HO2}) in a range of 1:5 to 5:1 while, in usual, they are suitably selected so that their mass ratio is in a range of 1:3 to 3:1 (e.g. 1:2 to 2:1). In a preferable embodiment, each of T_{HO1} and T_{HO2} is a terpene phenol resin.

The total amount of the tackifier resin relative to 100 parts by mass of the base polymer is not particularly limited while from the standpoint of combining high temperature cohesive strength and peel strength, in usual, it is suitably 20 parts by mass or greater, preferably 30 parts by mass or greater, or more preferably 40 parts by mass or greater (e.g. 50 parts by mass or greater). From the standpoint of the low temperature properties (e.g. low temperature peel strength), etc., in usual, the tackifier resin content relative to 100 parts by mass of the base polymer is suitably 200 parts by mass or less, preferably 150 parts by mass or less, or more preferably 120 parts by mass or less (e.g. 100 parts by mass or less).

Although not particularly limited, from the standpoint of the high temperature cohesive strength and repulsion resistance, etc., the total amount of tackifier resin T_{H} relative to 100 parts by mass of the base polymer (i.e. the total amount of the tackifier resin having a softening point of 120° C. or above) can be, for example, 10 parts by mass or greater, or preferably 20 parts by mass or greater (e.g. 25 parts by mass or greater). From the standpoint of the peel strength and low temperature properties (e.g. low temperature peel strength), etc., in usual, the tackifier resin T_{H} content relative to 100 parts by mass of the base polymer is suitably 120 parts by mass or less, preferably 100 parts by mass or less, more preferably 80 parts by mass or less (e.g. 60 parts by mass or less). With the total amount of tackifier resin T_{H} relative to 100 parts by mass of the base polymer being 55 parts by mass or less (e.g. 50 parts by mass or less), even greater peel strength can be obtained.

In an embodiment comprising a tackifier resin T_{L}, the total amount of tackifier resin T_{L} relative to 100 parts by mass or the base polymer is not particularly limited while it can be, for instance, 10 parts by mass or greater. From the standpoint of the peel strength, it is preferably 15 parts by mass or greater, or more preferably 20 parts by mass or greater. From the standpoint of the high temperature cohesive strength and repulsion resistance, the total amount of tackifier resin T_{L} relative to 100 parts by mass of the base polymer is suitably 120 parts by mass or less, preferably 90 parts by mass or less, or more preferably 70 parts by mass or less (e.g. 60 parts by mass or less). The tackifier resin T_{L} content can be 50 parts by mass or less (e.g. 40 parts by mass or less).

Among all the tackifier resins contained in the PSA composition disclosed herein, the ratio of tackifier resin T_{L} is not particularly limited. The ratio can be, for instance, 10 to 70% by mass, or it is usually preferable to be 20 to 50% by mass.

When the PSA composition disclosed herein comprises a tackifier resin T_{L} and a tackifier resin T_{H}, their amounts used are preferably selected so that the mass ratio T_{L}:T_{H} is 1:5 to 3:1 (more preferably 1:5 to 2:1). The art disclosed herein can be practiced preferably in an embodiment wherein the PSA comprises more of T_{H} than of T_{L} (e.g. the mass ratio T_{L}:T_{H} is 1:1.2 to 1:5) as the tackifier resin. According to such an embodiment, a PSA sheet of higher performance can be obtained.

Among all the tackifier resins contained in the PSA composition disclosed herein, the ratio of tackifier resin T_{H} is not particularly limited. The ratio can be, for instance, 30 to 90% by mass, or it is usually preferable to be 50 to 80% by mass.

Although not particularly limited, the tackifier resin T_{HR1} content in all the tackifier resins contained in the PSA composition disclosed herein can be, for instance, 1 to 100% by mass while, in usual, it is preferably 5 to 80% by mass, or more preferably 10 to 70% by mass. The same applies to the tackifier resin T_{HR2} content in all the tackifier resins contained in the PSA.

### <Isocyanate Compound>

The PSA composition disclosed herein may further comprise an isocyanate compound. According to such a PSA composition, can be obtained a PSA sheet of higher performance (e.g. having excellent repulsion resistance and peel property under a constant load). As the isocyanate compound, can be used preferably a polyfunctional isocyanate (which refers to a compound having an average of two or more isocyanate groups per molecule, including a compound having an isocyanurate structure). As the polyfunctional isocyanate, can be used one, two or more species selected from various isocyanate compounds (polyisocyanates) containing two or more isocyanate groups per molecule. Examples of such a polyfunctional isocyanate include aliphatic polyisocyanates, alicyclic polyisocyanates, aromatic polyisocyanates, and the like.

Examples of an aliphatic polyisocyanate include 1,2-ethylene diisocyanate; tetramethylene diisocyanates such as 1,2-tetramethylene diisocyanate, 1,3-tetramethylene diisocyanate, 1,4-tetramethylene diisocyanate, etc.; hexamethylene diisocyanates such as 1,2-hexamethylene diisocyanate, 1,3-hexamethylene diisocyanate, 1,4-hexamethylene diisocyanate, 1,5-hexamethylene diisocyanate, 1,6-hexamethylene diisocyanate, 2,5-hexamethylene diisocyanate, etc.; 2-methyl-L5-pentane diisocyanate, 3-methyl-L5-pentane diisocyanate, lysine diisocyanate, and the like.

Examples of an alicyclic polyisocyanate include isophorone diisocyanate; cyclohexyl diisocyanates such as 1,2-cyclohexyl diisocyanate, 1,3-cyclohexyl diisocyanate, 1,4-cyclohexyl diisocyanate, etc.; cyclopentyl diisocyanates such as 1,2-cyclopentyl diisocyanate, 1,3-cyclopentyl diisocyanate etc.; hydrogenated xylylene diisocyanate, hydrogenated tolylene diisocyanate, hydrogenated diphenylmethane diisocyanate, hydrogenated tetramethylxylene diisocyanate, 4,4′-dicyclohexylmethane diisocyanate, and the like.

Examples of an aromatic polyisocyanate include 2,4-tolylene diisocyanate, 2,6-tolylene diisocyanate, 4,4′-diphenylmethane diisocyanate, 2,4′-diphenylmethane diisocyanate, 2,2′-diphenylmethane diisocyanate, 4,4′-diphenylether diisocyanate, 2-nitrodiphenyl-4,4′-diisocyanate, 2,2′-diphenylpropane-4,4′-diisocyanate, 3,3′-dimethyldiphenylmethane-4,4′-diisocyanate, 4,4′-diphenylpropane diisocyanate, m-phenylene diisocyanate, p-phenylene diisocyanate, naphthylene-1,4-diisocyanate, naphthylene-1,5-diisocyanate, 3,3′-dimethoxydiphenyl-4,4′-diisocyanate, xylylene-1,4-diisocyanate, xylylene-1,3-diisocyanate and the like.

A preferable example of an isocyanate compound is a polyfunctional isocyanate having an average of three or more isocyanate groups per molecule. Such a tri-functional or higher polyfunctional isocyanate can be a multimer (typically a dimer or a trimer), a derivative (e.g., an addition product of a polyol and two or more polyfunctional isocyanate molecules), a polymer or the like of a di-functional, tri-functional, or higher polyfunctional isocyanate. Examples include polyfunctional isocyanates such as a dimer and a trimer of a diphenylmethane diisocyanate, an isocyanurate (a cyclic trimer) of a hexamethylene diisocyanate, a reaction product of trimethylol propane and a tolylene diisocyanate, a reaction product of trimethylol propane and a hexamethylene diisocyanate, polymethylene polyphenyl isocyanate, polyether polyisocyanate, polyester polyisocyanate, and the like. Commercial polyfunctional isocyanates include trade name “DURANATE TPA-100” available from Asahi Kasei Chemicals Corporation; trade names “CORONATE L”, “CORONATE HL”, “CORONATE HK”, “CORONATE HX”, “CORONATE 2096” available from Nippon Polyurethane Kogyo Co., Ltd.; and the like.

When an isocyanate compound is used, its amount used is not particularly limited. For instance, relative to 100 parts by mass of the base polymer, it can be more than zero part by mass, but 10 parts by mass or less (typically 0.01 to 10 parts by mass). In usual, an isocyanate compound can be used in an amount of suitably 0.1 to 10 parts by mass or preferably 0.1 to 5 parts by mass (typically 0.3 to 3 parts by mass, e.g., 0.5 to 1 part by mass) relative to 100 parts by mass of the base polymer. With use of an isocyanate compound in such a range, can be obtained a PSA sheet having particularly well-balanced properties.

### <Conductive Particles>

The PSA composition according to a preferable embodiment further comprises conductive particles in addition to the base polymer. This provides conductivity for PSA formed from the PSA composition. Typically, a PSA layer formed from the PSA composition may be conductive in the thickness direction. For the conductive particles, known species can be used. Examples include metals such as nickel, iron, chromium, cobalt, aluminum, antimonium, molybdenum, copper, silver, platinum, gold, tin, bismuth, etc.; alloys and oxides of these; carbon particles such as carbon black, etc.; and conductive particles obtainable by coating polymer beads, glass, resin, etc., with these. Among these, solely one species or a combination of two or more species can be used. In particular, metal particles and metal-coated particles are preferable, with nickel particles being particularly preferable among these.

The shape of conductive particles is not particularly limited. For example, they can be spherical, flaky, spiky, etc. From the standpoint of the dispersibility and conductivity, the conductive particles are preferably spherical or spiky. The aspect ratio of a conductive particle is not particularly limited and can be preferably selected from a range of, for instance, 1 to 10 (typically 1 to 5). The aspect ratio can be measured by scanning electron microscopy (SEM).

The average particle diameter of conductive particles is not particularly limited. From the standpoint of obtaining high conductivity while preventing flaws such as poor appearance and so on, for example, it is suitably 0.1 μm to 100 μm, preferably 1 μm to 50 μm, or more preferably 5 μm to 30 μm. For the average particle diameter, the 50th percentile value d₅₀ measured by a laser diffraction-scattering method can be used. As the measurement device, for instance, can be used a laser diffraction scattering particle size distribution analyzer “MT3300” available from Nikkiso Co., Ltd.

From the standpoint of obtaining good conductivity, the conductive particle content is suitably about 0.01 part by mass or higher, preferably 0.1 part by mass or higher, or more preferably 1 part by mass or higher (e.g. 5 parts by mass or higher, typically 25 parts by mass or higher) relative to 100 parts by mass of all non-volatiles in the PSA composition excluding the conductive particles. From the standpoint of maintaining good adhesive properties, the content is preferably 100 parts by mass or lower, more preferably 75 parts by mass or lower, or more preferably 50 parts by mass or lower (e.g. 40 parts by mass or lower, typically 15 parts by mass or lower).

### <Other Components>

The PSA composition disclosed herein may comprise one, two or more species of rubbery polymer as necessary besides the base polymer. Such a rubbery polymer can be one of various polymers known in the PSA field, such as rubber-based polymers, acrylic polymers, polyester-based polymers, urethane-based polymers, polyether-based polymers, silicone-based polymers, polyamide-based polymers, fluorine-based polymers, and the like. Examples of a rubber-based rubbery polymer include natural rubber, styrene-butadiene rubber (SBR), acrylonitrile-butadiene rubber (NBR), isoprene rubber, chloroprene rubber, polyisobutylene, butyl rubber, regenerated rubber, and the like. When the PSA comprises other rubbery polymer(s) besides the base polymer, the other rubbery polymer(s) can be used in an amount of suitably 50 parts by mass or less, preferably 30 parts by mass or less, or more preferably 10 parts by mass or less (e.g., 5 parts by mass or less) relative to 100 parts by mass of the base polymer. The art disclosed herein can be practiced preferably in an embodiment wherein the PSA composition is essentially free of such other rubbery polymer besides the base polymer (e.g., an embodiment where the other rubbery polymer content is zero to 1 part by mass relative to 100 parts by mass of the base polymer).

The PSA composition disclosed herein may contain as necessary various additives generally used in the PSA field, such as leveling agent, crosslinking agent, crosslinking co-agent, plasticizer, softening agent, filler, colorant (pigment, dye, etc.), anti-static agent, anti-aging agent, ultraviolet light absorber, anti-oxidant, photostabilizing agent, and so on. With respect to these various additives, those heretofore known can be used by typical methods. The PSA disclosed herein can be made preferably in an embodiment essentially free of a liquid rubber such as liquid polybutene, etc., (e.g., where the liquid rubber content relative to 100 parts by mass of the base polymer is 1 part by mass or less, or may be even zero part by mass). According to such a PSA, it may be possible to obtain a PSA sheet exhibiting even higher repulsion resistance and/or greater peel property under a constant load.

In a preferable embodiment, the PSA composition may have a composition where the combined amount of the base polymer and the tackifier resin accounts for 90% by mass or more of the total mass of the PSA (i.e., the mass of a PSA layer constituted with this PSA). For example, in a preferable embodiment, the combined amount of the base polymer and the tackifier resin is 90 to 99.8% by mass (typically, for instance, 95 to 99.5% by mass) of the total mass of the PSA.

In another preferable embodiment, the PSA may have a composition essentially free of a chelate compound. Herein, the chelate compound refers to, for instance, a chelate complex of an alkaline earth metal oxide and a resin (an alkyl phenol resin, etc.) having a functional group (hydroxyl group, methylol group, etc.) capable of coordinating the oxide. The art disclosed herein can be practiced preferably in an embodiment where the PSA composition is essentially free of such a chelate compound or in an embodiment containing none or at most 1% by mass of a chelate compound. According to such an embodiment, it may be possible to obtain a PSA sheet exhibiting even greater adhesive strength.

The form of the PSA composition disclosed herein is not particularly limited, and can be, for instance, a solvent-based PSA composition containing a PSA (an adhesive component) having a composition described above in an organic solvent, a water-dispersed (typically, an aqueous emulsion-based) PSA composition containing a PSA dispersed in an aqueous solvent, a PSA composition of the hot-melt type or the like. From the standpoint of the PSA's applicability and the latitude in the choice of a substrate, etc., a solvent-based or a water-dispersed PSA composition can be used preferably. From the standpoint of obtaining even greater adhesive properties, a solvent-based PSA composition is especially preferable. A solvent-based PSA composition is preferable also in view of its excellent dispersibility for conductive particles and fillers. Such a solvent-based PSA composition can typically be prepared as a solution containing the respective components described above in an organic solvent. The organic solvent can be selected among known or conventional organic solvents. For instance, can be used any one species or a mixture of two or more species among aromatic compounds (typically aromatic hydrocarbons) such as toluene, xylene, etc.; acetic acid esters such as ethyl acetate, butyl acetate, etc.; aliphatic or alicyclic hydrocarbons such as hexane, cyclohexane, methyl cyclohexane, etc.; halogenated alkanes such as 1,2-dichloroethane, etc.; ketones such as methyl ethyl ketone, acetyl acetone, etc.; and the like. While not particularly limited, in usual, the solvent-based PSA composition is suitably prepared to have a solids content (NV) of 30 to 65% by mass (e.g., 40 to 55% by mass). Too low an NV tends to result in higher production costs while too high an NV may lower the workability such as the PSA's applicability, etc.

As for the method for obtaining a PSA sheet from a PSA composition, various conventionally known methods can be applied. For example, can be preferably employed a method (direct method) where the PSA composition is directly provided (typically applied) to a substrate and allowed to dry to form a PSA layer. Alternatively, can be employed a method (transfer method) where the PSA composition is provided to a releasable surface (e.g. a surface of a release liner, a release-treated back face of a support substrate, etc.) and allowed to dry to form a PSA layer on the surface, and the PSA layer is transferred to a substrate.

The PSA composition can be applied, for instance, with a known or commonly used coater such as gravure roll coater, reverse roll coater, kiss roll water, dip roll coater, bar coater, knife water, spray coater, or the like. From the standpoint of facilitating the crosslinking reaction and increasing the production efficiency, the PSA composition is dried preferably with heating. In usual, for example, the drying temperature can be preferably around 40° C. to 150° C. (typically 40° C. to 120° C., e.g. 50° C. to 120° C., or even 70° C. to 100° C.). The drying time is not particularly limited while it can be about a few tens of seconds to a few minutes (e.g. within about 5 minutes, preferably about 30 seconds to 2 minutes). Afterwards, an additional drying step may be included as necessary. While the PSA layer is typically formed continuously, it may be formed in a regular pattern of dots or stripes, etc., or in a random pattern.

### <Examples of Constitution of PSA Sheet>

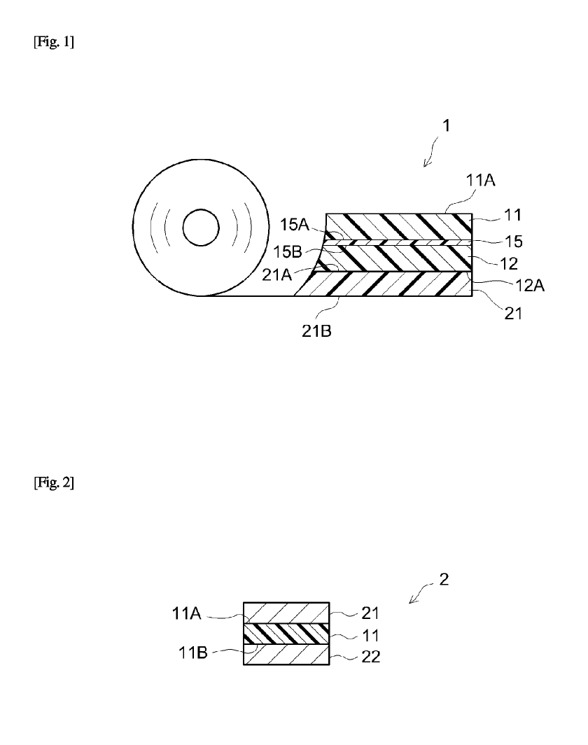

The PSA sheet disclosed herein (which can be a long sheet such as tape, etc.) may have, for example, a form of an adhesively double-faced PSA sheet having the cross-sectional structure shown in FIG. 1. A double-faced PSA sheet 1 comprises a substrate (e.g. plastic film) 15 as well as the first and second PSA layers 11 and 12 supported by the two faces of substrate 15, respectively. More specifically, first PSA layer 11 and second PSA layer 12 are provided on first face 15A and second face 15B of substrate 15, respectively, with both faces 15A and 15B being non-releasing. Prior to use (before adhered to an adherend), as shown in FIG. 1, double-faced PSA sheet 1 can be in a roll wherein PSA sheet 1 is wound along with release liner 21 having front face (release face) 21A and back face (release face) 21B. In double-faced PSA sheet 1 in such an embodiment, the surface (second adhesive face 12A) of second PSA layer 12 and the surface (first adhesive face 11A) of first PSA layer 11 are protected with front face 21A and back face 21B of release liner 21, respectively. Alternatively, it may be in an embodiment where first adhesive face 11A and second adhesive face 12A are protected with two separate release liners, respectively.

The art disclosed herein can be applied preferably to a substrate-containing double-faced PSA sheet as shown in FIG. 1, and can also be applied to a double-faced PSA sheet 2 that is free of a substrate (i.e., having no substrate) as shown in FIG. 2. Prior to use, double-faced PSA sheet 2 can be, for instance, in an embodiment as shown in FIG. 2 where the first adhesive face 11A and the second adhesive face 11B of substrate-free PSA layer 11 are protected with release liners 21 and 22, respectively, with each release liner comprising a release face at least on the PSA-layer-side surface (front face). Alternatively, it may be in an embodiment without release liner 22, wherein both the two faces of release liner 21 are release faces, and PSA layer 11 is overlaid therewith and wound in a roll so that the back face of release liner 21 contacts and protects second adhesive face 11B.

The art disclosed herein can be applied to an adhesively single-faced, substrate-containing PSA sheet 3 as shown in FIG. 3 as well, with the PSA sheet comprising a substrate 15 and a PSA layer 11 supported by the first face (non-release face) 15A of the substrate. Prior to use, PSA sheet 3 can be, for instance, in an embodiment as shown in FIG. 3 where a surface (adhesive face) 11A of PSA layer 11 is protected with a release liner 21 comprising a release face at least on the PSA-layer-side surface (front face). Alternatively, it may be in an embodiment without release liner 21, wherein substrate 15 comprises a release face on second face 15B, and substrate-containing PSA sheet 3 is wound in a roll so that second face 15B of substrate 15 contacts and protects first adhesive face 11A.

### <Substrate>

When the art disclosed herein is applied to a substrate-containing, double-faced or single-faced PSA sheet, a suitable substrate can be selected and used according to the intended purpose of the PSA sheet among plastic films such as polypropylene films, ethylene-propylene copolymer films, polyester films, polyvinyl chloride films, etc.; foam sheets made of foam such as polyurethane foam, polyethylene foam, polychloroprene foam, etc.; woven fabrics and non-woven fabrics (meaning to include paper such as Washi, high-grade paper, etc.) of a single species or a blend, etc., of various species of fibrous substances (which can be natural fibers such as hemp, cotton, etc.; synthetic fibers such as polyester, vinylon, etc.; semi-synthetic fibers such as acetate, etc.; and the like); metal foil such as aluminum foil, copper foil, etc.; and the like. The plastic film (typically referring to a non-porous plastic film, which should be conceptually distinguished from a woven fabric and a non-woven fabric) may be a non-stretched film, or a stretched (uni-axially stretched or bi-axially stretched) film. The substrate surface to be provided with a PSA layer may have been subjected to a surface treatment such as primer coating, corona discharge treatment, plasma treatment, or the like. While the thickness of the substrate can be suitably selected according to the purpose, in general, it is about 2 μm to 500 μm (typically 10 μm to 200 μm).

Examples of the non-woven fabric utilized for the substrate disclosed herein include non-woven fabrics constituted with natural fibers including pulp such as wood pulp and the like, cotton, hemp, etc.; non-woven fabrics constituted with artificial fibers (synthetic fibers) including polyester fibers such as polyethylene terephthalate (PET) fibers, etc., rayon, vinylon, acetate fibers, polyvinyl alcohol (PVA) fibers, polyamide fibers, polyolefin fibers, polyurethane fibers, etc.; non-woven fabrics constituted with two or more materially different species of fibers used together; and the like. In particular, from the standpoint of the PSA's impregnating ability and repulsion resistance, non-woven fabrics constituted with pulp or hemp (e.g. hemp pulp) and non-woven fabrics constituted with PET fibers are preferable. The utilization of a non-woven fabric substrate contributes also to increase the flexibility or hand-tearability of the PSA sheet.

A preferable non-woven fabric (non-woven fabric substrate) in the art disclosed herein has a grammage of about 30 g/m² or less (e.g. 25 g/m² or less, typically 20 g/m² or less). A non-woven fabric having such a grammage is suitable for fabrication of a lightweight PSA sheet having excellent adhesive properties. From the standpoint of the repulsion resistance, a non-woven fabric having a grammage less than 18 g/m² (e.g. 16 g/m² or less, typically 15 g/m² or less) is preferable. From the standpoint of increasing the strength of the substrate itself, the grammage is preferably 10 g/m² or greater (e.g. 12 g/m² or greater, typically 13 g/m² or greater).

In the art disclosed herein, it is usually suitable that the non-woven fabric substrate has a thickness of about 150 μm or smaller. From the standpoint of allowing PSA to thoroughly impregnate the entire substrate, the thickness is preferably 100 μm or smaller (e.g. 70 μm or smaller, typically 60 μm or smaller). In view of the handlings during fabrication of the PSA sheet, the thickness is preferably 10 μm or larger (e.g. 25 μm or larger, typically 30 μm or larger). From the standpoint of the repulsion resistance, the thickness is preferably 30 μm to 60 μm (e.g. 35 μm to 50 μm, typically 40 μm to 45 μm).

It is usually suitable that the non-woven fabric substrate has a bulk density (which is calculated by dividing the grammage by the thickness) of about 0.20 g/cm³ to 0.50 g/cm³, or preferably about 0.25 g/cm³ to 0.40 g/cm³. With the bulk density being within these ranges, the substrate itself will have suitable strength, making itself greatly susceptible to PSA impregnation. From the standpoint of the repulsion resistance, it is particularly preferable to use a non-woven fabric substrate having a bulk density of about 0.25 g/cm³ to 0.40 g/cm³ (e.g. 0.30 g/cm³ to 0.35 g/cm³).

It is preferable that the non-woven fabric substrate satisfies two or more features among the grammage, the thickness and the bulk density in the preferable ranges (e.g. the grammage and the thickness, more preferably all of the grammage, the thickness and the bulk density). By this means, it may be possible to obtain a PSA sheet exhibiting highly balanced several adhesive properties (e.g. repulsion resistance, high temperature cohesive strength, peel strength, etc.).

The non-woven fabric substrate may comprise, in addition to the constituent fibers as described above, a resin component such as starch (e.g. cationized starch), polyacrylamide, viscose, polyvinyl alcohol, urea formaldehyde resin, melamine formaldehyde resin, polyamide polyamine epichlorohydrin resin, or the like. The resin component may function as a paper strengthening agent for the non-fabric substrate. By using such a resin component as necessary, the strength of the non-woven fabric substrate can be adjusted. The non-woven fabric substrate in the art disclosed herein may comprise as necessary additives generally used in the fields related to production of non-woven fabrics, such as yield-increasing agent, drainage-aiding agent, viscosity-adjusting agent, dispersant, and the like.

When constituting the PSA sheet in the art disclosed herein as a conductive PSA sheet, the conductive PSA sheet may be a substrate-free PSA sheet (typically a sheet consisting of a PSA layer), or it may be constituted by forming a conductive PSA layer on one or each face of a conductive substrate. In the conductive PSA sheet according to a preferable embodiment, a conductive PSA layer comprising conductive particles is provided on at least one face (typically on one face) of a conductive substrate.

For the conductive substrate, metal foil can be preferably used. Specific examples include metal foil formed of copper, aluminum, nickel, silver, iron, lead, tin or an alloy of these, etc. In particular, from the standpoint of the conductivity, workability and so on, aluminum foil and copper foil are preferable while copper foil is more preferable. Among copper foil species, electrolytic copper foil is preferably used. The copper foil may be subjected to various surface treatments such as plating, etc. The thickness of the conductive substrate is not particularly limited. A preferable conductive substrate has a thickness of about 5 μm to 300 μm (e.g. 10 μm to 100 μm, typically 15 μm to 70 μm).

### <PSA Layer>

Although not particularly limited, the PSA layer suitably has a thickness of about 4 μm to 150 μm (typically 20 μm to 120 μm, e.g. 30 μm to 100 μm). With respect to a substrate-containing double-faced PSA sheet, the constitution may be such that a PSA layer having the thickness is provided on each face of the substrate. When providing a PSA layer with conductivity by means of including conductive particles, from the standpoint of obtaining good conductivity in the thickness direction, the PSA layer preferably has a thickness of about 100 μm or smaller (more preferably 50 μm or smaller, even more preferably 30 μm or smaller). From the standpoint of combining conductivity and adhesive properties, it is preferable that the PSA layer has a thickness of 5 μm or larger (e.g. 10 μm or larger). While the PSA layer is typically formed continuously, it may be formed in a regular pattern of dots or stripes, etc., or in a random pattern.

### <Release Liner>

There are no limitations to the release liner, and any conventional release paper or the like can be used. For example, the following can be used: a release liner having a release layer on a surface of a substrate such as a plastic film or a sheet of paper, etc.; a release liner formed from a poorly-adhesive material such as a fluorine-based polymer (polytetrafluoroethylene, etc.) or a polyolefin-based resin (polyethylene, polypropylene, etc.); or the like. The release layer can be formed, for instance, by processing the surface of the substrate with a release agent such as a silicone-based, a long-chain alkyl-based, a fluorine-based, a molybdenum disulfide-based release agent or the like.

### <Applications>

The PSA composition or the PSA sheet disclosed herein is useful for joining components to each other in various types of OA equipment, home appliances, automobiles, etc., (e.g. for fastening various components in such products). In particular, it is preferable for joining an elastic resin sheet (e.g. plastic film having a thickness of about 0.05 mm to 0.2 mm) to a housing made of a resin such as acrylonitrile-butadiene-styrene copolymer (ABS), high impact polystyrene (HIPS), a polymer blend (PC/ABS) of polycarbonate (PC) and ABS, and so on, or to an aluminum housing. Examples of products having such joints include toner cartridges, printers, notebook PCs, and mobile devices such as mobile phones, smart phones and mobile tablets, etc. The conductive PSA sheet disclosed herein can be preferably used as a conductive adhesive component in various electronic devices. The conductive PSA sheet can be preferably used also for shielding electromagnetic waves and preventing static electricity in electronic devices, cables and so on.

### <Properties of PSA Sheet>

In a preferable embodiment, the PSA sheet disclosed herein is such that in a heat resistance test (more specifically, the test is carried out according to the heat resistance test method described later in the worked examples) where the PSA sheet is pressure-bonded over a 10 mm wide by 20 mm long surface area to a stainless steel plate (SUS304 plate) as an adherend with a 2 kg roller moved back and forth once, and the resultant is left hanging in an environment at 80° C. for 30 minutes, and subsequently left with a 500 g load applied thereto in the same environment for one hour; the time required for the PSA sheet to peel off the adherend after the load is applied is one hour or longer.

In another preferable embodiment, the PSA sheet disclosed herein typically has a 180° peel strength (N/20 mm-width) of 10 N/20 mm or greater when measured by pressure-bonding the PSA sheet to a surface of a stainless steel plate (SUS304 plate) as an adherend with a 2 kg roller moved back and forth once in an environment at 23° C. and 50% RH; leaving the resultant for 30 minutes; and subsequently, taking a measurement at a tensile speed of 300 mm/min based on JIS Z0237 (more specifically, the measurement is taken according to the 180° peel strength measurement method described later in the worked examples). The 180° peel strength is preferably 15 N/20 mm or greater, or more preferably 20 N/20 mm or greater. The PSA sheet according to a particularly preferable embodiment may have a 180° peel strength (N/20 mm-width) of 25 N/20 mm or greater (or even 30 N/20 mm or greater).

In a preferable embodiment, the PSA sheet disclosed herein may result in a floating distance of 5 mm or smaller in a repulsion resistance test method described later in the worked examples, when the floating distance is measured after pressure-bonding the PSA sheet to an aluminum cylinder as an adherend and leaving the resultant in an environment at 70° C. and 80% RH for 12 hours. In a more preferable embodiment, the floating distance is 3 mm or smaller (e.g. 1.8 mm or smaller, typically 1.2 mm or smaller).

When constituting the PSA sheet disclosed herein as a conductive PSA sheet, it is preferable that the PSA sheet has a resistance value of 0.9Ω or lower (e.g. 0.3Ω or lower, typically 0.1Ω or lower). The resistance of the PSA sheet is measured by the method described later in the worked examples.

The overall thickness of the PSA sheet disclosed herein is not particularly limited. From the standpoint of making it thinner, smaller, lighter and resource-saving, etc., it is preferably about 1000 μm or smaller (e.g. 500 μm or smaller, typically 300 μm or smaller). From the standpoint of assuring good adhesive properties, it is suitably 50 μm or larger (e.g. 70 μm or larger, typically 100 μm or larger). When the PSA sheet disclosed herein is conductive, from the standpoint of the conductivity, etc., the overall thickness of the PSA sheet is preferably about 150 μm or smaller (e.g. 120 μm or smaller, typically 90 μm or smaller).

### <PSA Sheet Comprising a Foam Substrate>

An example of preferable applications of the PSA composition disclosed herein is production of a PSA sheet comprising a foam substrate sheet and a PSA layer provided on one or each face of the foam substrate. The foam substrate sheet refers to a substrate comprising a portion having air bubbles (a bubble porous structure), typically referring to a substrate comprising a thin layer of foam (a foam layer) as a component. The foam substrate may essentially consist of one, two or more foam layers, or may be a complex substrate comprising a foam layer and a non-foam layer (e.g., the substrate may comprise the foam layer and the non-foam layer overlaid on top of each other). Herein, the non-foam layer refers to a layer not having a bubble porous structure. When the foam substrate comprises two or more foam layers, they can be of the same or different materials and structures.

The following description refers to, as a main example, a double-faced PSA sheet (a foam substrate-containing double-faced PSA sheet) comprising a foam substrate constituted to essentially consist of a single foam layer, and a PSA layer formed from a PSA composition disclosed herein and provided on each face of the foam substrate. However, it is not to limit the constitution of the PSA sheet disclosed herein.

The thickness of the foam substrate can be suitably selected in accordance with the strength, flexibility, and intended purposes, etc., of the PSA sheet. From the standpoint of ensuring to obtain a PSA layer thickness capable of producing desirable adhesive properties, in usual, the foam substrate has a thickness of suitably 350 μm or smaller (e.g., 300 μm or smaller), preferably 250 μm or smaller, or more preferably 220 μm or smaller, e.g., 200 μm or smaller. A foam substrate having a thickness of 180 μm or smaller can be used as well. From the standpoint of the repulsion resistance and the impact resistance of the double-faced PSA sheet, etc., the thickness of the foam substrate is suitably 30 μm or larger, preferably 40 μm or larger, or more preferably 50 μm or larger (e.g., 60 μm or larger).

The material of the foam substrate is not particularly limited. It is usually preferable to use a foam substrate comprising a layer formed of plastic foam (foam of a plastic material). The plastic material (meaning to also encompass rubber materials) for forming the plastic foam is not particularly limited, and can be suitably selected among known plastic materials. One species of plastic material can be used solely, or two or more species can be used in combination.

Specific examples of a plastic foam include polyolefin-based resin foams such as polyethylene foams, polypropylene foams, etc.; polyester-based resin foams such as polyethylene terephthalate foams, polyethylene naphthalate foams, polybutylene terephthalate foams, etc.; polyvinyl chloride-based resin foams such as polyvinyl chloride foams, etc.; vinyl acetate-based resin foams; polyphenylene sulfide resin foams; amide-based resin foams such as polyamide (nylon) resin foams, wholly aromatic polyamide (aramid) resin foams, etc.; polyimide-based resin foams; polyether ether ketone (PEEK) resin foams; styrene-based resin foams such as polystyrene foams, etc.; urethane-based resin foams such as polyurethane resin foams, etc.; and the like. Alternatively, as the plastic foam, can be used a rubber-based resin foam such as a polychloroprene rubber foam or the like.

Examples of preferable foam include polyolefin-based resin foams. As the plastic material (i.e., a polyolefin-based resin) constituting the polyolefin-based foam, can be used a known or conventional polyolefin-based resin of various types without any particular limitations. Examples include polyethylenes such as low density polyethylenes (LDPE), linear low density polyethylenes (LLDPE), high density polyethylenes (HDPE), metallocene-catalyst-based linear low density polyethylenes, etc.; polypropylenes; ethylene-propylene copolymers; ethylene-vinyl acetate copolymers; and the like. Among these polyolefin-based resins, can be used one species alone, or two or more species in a suitable combination.

From the standpoint of the impact resistance and the water resistance, particularly preferable examples of the foam substrate in the art disclosed herein include a polyethylene-based foam substrate consisting essentially of a polyethylene-based resin foam, a polypropylene-based foam substrate consisting essentially of a polypropylene-based resin foam, and the like. Herein, the polyethylene-based resin refers to a resin formed from ethylene as the primary monomer (i.e., the primary component among monomers), with the resin encompassing HDPE, LDPE and LLDPE as well as ethylene-propylene copolymers and ethylene-vinyl acetate copolymers each having a copolymerization ratio of ethylene exceeding 50% by mass, and the like. Similarly, the polypropylene-based resin refers to a resin formed from propylene as the primary monomer. As the foam substrate in the art disclosed herein, can be preferably used a polyethylene-based foam substrate.

Although not particularly limited, in typical, gas bubbles in the foam substrate has an average diameter of preferably 10 μm to 1000 μm, or more preferably 20 μm to 600 μm. With an average gas bubble diameter of 10 μm or larger, the impact resistance tends to increase. On the other hand, with an average gas bubble diameter of 1000 μm or smaller, the water resistance (water shielding ability) tends to increase. The average gas bubble diameter can be measured, for instance, by an optical microscope.

Although not particularly limited, in typical, the foam substrate has a density (an apparent density) of preferably 0.1 g/cm³ to 0.5 g/cm³, or more preferably 0.2 g/cm³ to 0.4 g/cm³. With a density of 0.1 g/cm³ or larger, the strength (e.g., the tensile strength) of the foam substrate (and even the strength of the double-faced PSA sheet) increases, and the impact resistance and the handling properties tend to increase. On the other hand, with a density of 0.5 g/cm³ or smaller, the flexibility is kept at a sufficient level, and the conformability to uneven surfaces tends to increase. With good conformability to uneven surfaces, in general, even when the double-faced PSA sheet is adhered to an adherend having an uneven surface (e.g., a surface having a step), interstices are less likely to be formed in the interface between the PSA sheet and the adherend surface, whereby the water resistance increases. The density (apparent density) of a foam substrate can be measured, for instance, by a method based on JIS K6767.

Although not particularly limited, in typical, the foam substrate has an expansion ratio of preferably 2 cm³/g to 10 cm³/g, or more preferably 2.5 cm³/g to 5 cm³/g. With an expansion ratio of 2 cm³/g or larger, the flexibility increases, and the conformability to uneven surfaces tends to increase. On the other hand, with an expansion ratio of 10 cm³/g or smaller, the strength of the foam substrate (and even the strength of the double-faced PSA sheet) increases, and the impact resistance and the handling properties tend to increase. As used herein, the expansion ratio of a foam substrate is defined as the reciprocal of its apparent density (g/cm³) measured based on JIS K6767.

The elongation of the foam substrate (e.g., a polyolefin-based foam substrate) is not particularly limited. For example, the foam substrate has an elongation of preferably 200 to 800% (more preferably 400 to 600%) in the machine direction (MD) and an elongation of preferably 50 to 800% (more preferably 100 to 600%) in the transverse direction (TD). With an elongation equal to or greater than the lower limit cited above, the impact resistance and the conformability to uneven surfaces may increase. On the other hand, with an elongation equal to or less than the upper limit cited above, the strength of the foam substrate increases, and the impact resistance tends to increase. The elongation of a foam substrate is measured based on JIS K6767. The elongation of the foam substrate can be adjusted, for instance, by modifying the degree of crosslinking and the expansion ratio, etc.

The tensile strength of the foam substrate (e.g., a polyolefin-based foam substrate) is not particularly limited. For example, the foam substrate has a tensile strength in the MD of preferably 0.5 MPa to 20 MPa (more preferably 1 MPa to 15 MPa) and a tensile strength in the TD of preferably 0.2 MPa to 20 MPa (more preferably 0.5 MPa to 15 MPa). With MD and TD tensile strengths equal to or higher than the respective lower limits cited above, the handling properties of the foam substrate and the double-faced PSA sheet may increase. On the other hand, with MD and TD tensile strengths equal to or lower than the respective upper limits cited above, the impact resistance and the conformability to uneven surfaces may increase. The tensile strength (MD tensile strength and TD tensile strength) of a foam substrate is measured based on JIS K6767. The tensile strength of the foam substrate can be adjusted, for instance, by modifying the degree of crosslinking and the expansion ratio, etc.

The foam substrate (e.g., a polyolefin-based foam substrate) preferably has a compressive hardness that corresponds to a load of 10 kPa to 300 kPa (more preferably 30 kPa to 200 kPa) required for compressing layers of the foam substrate stacked to an initial thickness of about 25 mm to 25% of the initial thickness. A compressive hardness of 10 kPa or greater may give rise to greater handling properties. On the other hand, with a compressive hardness of 300 kPa or smaller, the conformability to uneven surfaces may increase. The compressive hardness of a foam substrate is measured based on JIS K6767. The compressive hardness of the foam substrate can be adjusted, for instance, by modifying the degree of crosslinking and the expansion ratio, etc.

The foam substrate may contain various additives as needed such as fillers (inorganic fillers, organic fillers, etc.), anti-aging agent, antioxidant, UV (ultraviolet ray) absorber, anti-static agent, slipping agent, plasticizers, flame retardant, surfactant, and so on.

The foam substrate in the art disclosed herein may be colored in order to develop desirable design or optical properties (e.g., light-blocking ability, light-reflecting ability, etc.) in the double-faced PSA sheet. For coloring the foam substrate, among known organic or inorganic colorants, can be used solely one species, or two or more species in a suitable combination.

For example, when the foamed substrate-containing double-faced PSA sheet disclosed herein is used for a light blocking purpose, although not particularly limited, the foam substrate has a visible light transmittance of preferably 0 to 15% or more preferably 0 to 10%, similarly to the visible light transmittance of the double-faced PSA sheet described later. When the double-faced PSA tape disclosed herein is used for a light reflecting purpose, the foam substrate has a visible light reflectivity of preferably 20 to 100% or more preferably 25 to 100%, similarly to the visible light reflectivity of the double-faced PSA tape.

The visible light transmittance of a foam substrate can be determined by irradiating one face of the foam substrate with 550 nm wavelength light using a spectrophotometer (e.g., a spectrophotometer under model number “U-4100” available from Hitachi High-Technologies Corporation) and measuring the intensity of the light transmitted to the other side of the foam substrate. The visible light reflectivity of a foam substrate can be determined by irradiating one face of the foam substrate with 550 nm wavelength light using the spectrophotometer and measuring the intensity of the light reflected by the foam substrate. The visible light transmittance and the visible light reflectivity of a double-faced PSA sheet can be determined by the same methods as well.

When the foam substrate-containing double-faced PSA sheet disclosed herein is used for a light blocking purpose, it is preferable that the foam substrate is colored black. The black color has a lightness (L*) as specified by the L*a*b* color space of preferably 35 or lower (e.g., 0 to 35), or more preferably 30 or lower (e.g., 0 to 30). The values of a* and b* as specified by the L*a*b* color space can be suitably selected according to the value of L*. Neither a* nor b* is particularly limited, but it is preferable that each value is in a range of −10 to 10 (more preferably −5 to 5, or even more preferably −2.5 to 2.5). For example, it is preferable that each of a* and b* is zero or near zero.

In the present description, he values of L*, a* and b* as specified by the L*a*b* color space can be determined through measurements with a colorimeter (e.g., colorimeter under trade name “CR-200” available from Konica Minolta Holdings Inc.). The L*a*b* color space refers to the CIE 1976 (L*a*b*) color space defined by the International Commission on Illumination (CIE) in 1976. In Japanese Industrial Standards (JIS), the L*a*b* color space is specified in JIS Z8729.

Examples of a black colorant for coloring the foam substrate black include carbon blacks (furnace black, channel black, acetylene black, thermal black, lamp black, etc.), graphite, copper oxide, manganese(IV) oxide, aniline black, perylene black, titanium black, cyanine black, activated carbon, ferrites (non-magnetic ferrite, magnetic ferrite, etc.), magnetite, chromium oxide, iron oxide, molybdenum disulfide, chromium complexes, composite-oxide-based black colorants, anthraquinone-based organic black colorants, and the like. From the standpoint of the cost and the availability, for example, carbon blacks are preferable as the black colorant. The amount of black colorants is not particularly limited, and they can be used in an amount suitable for producing desirable optical properties.

When the foam substrate-containing double-faced PSA sheet is used for a light reflecting purpose, it is preferable that the foam substrate is colored white. The white color has a lightness (L*) of preferably 87 or higher (e.g., 87 to 100), or more preferably 90 or higher (e.g., 90 to 100). The values of a* and b* as specified by the L*a*b* color space can be suitably selected according to the value of L*. It is preferable that each of a* and b* is in a range of −10 to 10 (more preferably −5 to 5, or even more preferably −2.5 to 2.5). For example, it is preferable that each of a* and b* is zero or near zero.

Examples of a white colorant include inorganic white colorants such as titanium oxides (e.g., titanium dioxides such as rutile titanium dioxide, anatase titanium dioxide, etc.), zinc oxide, aluminum oxide, silicon oxide, zirconium oxide, magnesium oxide, calcium oxide, tin oxide, barium oxide, cesium oxide, yttrium oxide, magnesium carbonate, calcium carbonates (light calcium carbonate, heavy calcium carbonate, etc.), barium carbonate, zinc carbonate, aluminum hydroxide, calcium hydroxide, magnesium hydroxide, zinc hydroxide, aluminum silicate, magnesium silicate, calcium silicate, barium sulfate, calcium sulfate, barium stearate, zinc oxide, zinc sulfide, talc, silica, alumina, clay, kaolin, titanium phosphate, mica, gypsum, white carbon, diatomaceous earth, bentonite, lithopone, zeolite, sericite, hydrated halloysite, etc.; organic white colorants such as acrylic resin particles, styrene-based resin particles, urethane-based resin particles, amide-based resin particles, polycarbonate-based resin particles, silicone-based resin particles, urea-formaldehyde-based resin particles, melamine resin particles, etc.; and the like. The amount of white colorants is not particularly limited, and they can be used in an amount suitable for producing desirable optical properties.

The surface of the foam substrate may be pre-subjected to a suitable surface treatment as necessary. The surface treatment may be a chemical or a physical process to increase the adhesion between itself and its adjacent material (e.g., a PSA layer). Examples of such a surface treatment include corona discharge, chromic acid treatment, exposure to ozone, exposure to flame, UV irradiation, plasma treatment, primer application, and the like.

The foam substrate-containing double-faced PSA sheet disclosed herein may comprise such a foam substrate, a first PSA layer and a second PSA layer. The total thickness of such a double-faced PSA sheet (referring to the combined thickness of the foam substrate and the PSA layers provided on its two faces, not including the thickness of any release liner) is not particularly limited. In a preferable embodiment, the foam substrate-containing double-faced PSA sheet has a total thickness of 400 μm or smaller (typically 350 μm or smaller). From the standpoint of making it thinner, smaller, lighter and resource saving, etc., a preferable foam substrate-containing double-faced PSA sheet has a total thickness of 300 μm or smaller (more preferably 250 μm or smaller, e.g. 230 μm or smaller). While the lower limit of the total thickness of the double-faced PSA sheet is not particularly limited, from the standpoint of the impact resistance and water resistance, etc., in usual, it is suitably 50 μm or larger, or preferably 70 μm or larger (more preferably 100 μm or larger, or even 150 μm or larger, e.g. 190 μm or larger).

The total thickness of the PSA layers provided on both sides of the foam substrate is not particularly limited. In a preferable embodiment, the total thickness of the PSA layers can be 10 μm to 200 μm. From the standpoint of the adhesive properties, in usual, the total thickness of the PSA layers is suitably 20 μm or larger, preferably 30 μm or larger, or more preferably 40 μm or larger. From the standpoint of ensuring to obtain a foam substrate thickness capable of producing desirable properties, in usual, the two PSA layers have a combined thickness of suitably 170 μm or smaller, preferably 150 μm or smaller, or more preferably 100 μm or smaller (e.g., 80 μm or smaller).

The thickness of the first PSA layer and the thickness of the second PSA layer may be the same or different. It is usually preferable to employ a constitution where the two PSA layers have about the same thickness. When the two PSA layers are formed from the PSA described above (i.e., a PSA comprising as a base polymer a block copolymer of a monovinyl-substituted aromatic compound and a conjugated diene compound), each PSA layer may have a thickness of, for instance, 5 μm to 100 μm, preferably 10 μm to 75 μm, or more preferably 15 μm to 65 μm (e.g., 20 μm to 40 μm). Each PSA layer may consist of a single layer or multiple sub-layers.

The double-faced PSA sheet disclosed herein may further comprise other layer(s) (an intermediate layer, a undercoat layer, etc., which may be referred to as “optional layer(s)”) besides the foam substrate and the two PSA layers as far as the effects of the present invention are not significantly interfered. For example, the optional layer(s) may be present between the foam substrate and one or each of the two PSA layers. In a double-faced PSA sheet having such a constitution, the thickness of the optional layer(s) is included in the overall thickness of the double-faced PSA sheet (i.e., the thickness from one PSA layer surface to the other PSA layer surface).

The foam substrate-containing double-faced PSA sheet disclosed herein may exhibit desirable optical properties (transmittance, reflectivity, etc.). For instance, when used for a light blocking purpose, the double-faced PSA sheet has a visible light transmittance of preferably 0% to 15% (more preferably 0% to 10%). When used for a light reflecting purpose, the double-faced PSA sheet has a visible light reflectivity of preferably 20% to 100% (more preferably 25% to 100%). The optical properties of the double-faced PSA sheet can be adjusted by, for instance, coloring the foam substrate as described above or by like methods.

From the standpoint of preventing corrosion of metal, etc., the foam substrate-containing double-faced PSA sheet disclosed herein is preferably free of halogens. Absence of halogens in the double-faced PSA sheet can be advantageous, for example, when the double-faced PSA sheet is used for fastening electric/electronic components. It is also preferable from the standpoint of reducing environmental stress since the generation of halogen-containing gas during incineration can be suppressed. A halogen-free double-faced PSA sheet can be produced by employing a single means or a few means together among means such as avoiding deliberate inclusion of a halogen compound into the raw materials for forming the foam substrate or the PSA, using a foam substrate formed without deliberate inclusion of a halogen compound, avoiding additives derived from halogen compounds when any additives are used, and other like means.

The applications of the foam substrate-containing double-faced PSA sheet disclosed herein are not particularly limited. It can be used on an adherend formed from, for instance, a metal material such as stainless steel (SUS), aluminum, etc.; an inorganic material such as glass, ceramics, etc.; a resin material such as polycarbonate, polymethyl methacrylate (PMMA), polypropylene, polyethylene terephthalate (PET), etc.; a rubber material such as natural rubber, a butyl rubber, etc.; a composite material of these; or the like.

The double-faced PSA sheet disclosed herein may exhibit excellent impact resistance and conformability to uneven surfaces because it comprises a foam substrate, and it may also exhibit excellent repulsion resistance for a relatively small overall thickness. Thus, taking advantage of these characteristics, it can be preferably applied to purposes involving electronic devices, for instance, for fastening a glass screen or a key module in a mobile phone, for absorbing impact forces applied to an electronic device, for fastening a decorative TV panel, for protecting a PC battery pack, for waterproofing a digital camcorder lens, and for like purposes. It can be particularly preferably used for mobile electronic devices, especially those (e.g., mobile phones, smartphones, etc.) having liquid crystal displays. For instance, in these mobile electronic devices, it can be used particularly preferably for attaching display panels to their cases.

### EXAMPLES

Several worked examples relating to the present invention are described below, but the present invention is not intended to be limited to these examples. In the description below, “parts” and “%” are based on the mass unless otherwise specified. The physical properties in the description below were measured or evaluated as follows.

### (1) Heat Resistance

From a double-faced PSA sheet, the release liner covering the first adhesive face was removed, and a 25 μm thick PET film was adhered as a backing. The backed PSA sheet was cut to 10 mm wide by 100 mm long to prepare a measurement sample. The release liner covering the second adhesive face of the measurement sample was removed, and the second adhesive face was pressure-bonded over a 10 mm wide by 20 mm long surface area to a stainless steel plate (SUS304 plate) as an adherend with a 2 kg roller moved back and forth once. The measurement sample thus adhered on the adherend was left hanging in an environment at 80° C. for 30 minutes and a 500 g load was applied to the free end of the measurement sample. Based on JIS Z0237, it was left with the load applied in the environment at 80° C. for one hour. Subsequently, the distance (mm) the measurement sample moved from the initially adhered position was measured. When the measured sample peeled off the adherend and fell within one hour after the load was applied, the time (min) it took from the load application until it fell off was measured.

### (2) 180° Peel Strength

To the first adhesive face of a double-faced PSA sheet, a 25 μm thick PET film was adhered. This was cut to 20 mm wide by 100 mm long pieces to prepare test samples.

### (Ambient Temperature Peel Strength)

In an environment at 23° C. and 50% RH, the second adhesive face of each measurement sample was exposed and pressure-bonded to an adherend surface with a 2 kg roller moved back and forth once. The resultant was left in the same environment for 30 minutes, and based on JIS Z 0237, using a universal tensile and compression tester (product name “Tensile and Compression Testing Machine, TG-1kN” available from Minebea Co., Ltd.), the ambient temperature peel strength (N/20 mm-width) was measured at a tensile speed of 300 mm/min and a peel angle of 180°. For the adherend, a stainless steel plate (SUS304 plate) was used

### (Low Temperature Peel Strength)

A measurement sample and an adherend were stored in an environment at 0° C. for one hour or more and in the same environment (0° C.), in the same manner as the ambient temperature SUS adhesive strength, the measurement sample was pressure-bonded to the adherend and the resultant was left in the same environment for 30 minutes. Subsequently, based on JIS Z 0237, using a universal tensile and compression tester (product name “Tensile and Compression Testing Machine, TG-1kN” available from Minebea Co., Ltd.), the low temperature peel strength (N/20 mm-width) was measured at a tensile speed of 300 mm/min and a peel angle of 180°. For the adherend, a stainless steel plate (SUS304 plate) was used.

### Experiment 1

### Preparation of PSA Compositions

### Example a1

100 parts of a styrene-isoprene block copolymer (available from Zeon Corporation, product name “QUINTAC 3520”, 15% styrene content, 78% diblock fraction) as a base polymer, 20 parts of an aromatic petroleum resin (available from JX Nippon Oil & Energy Corporation, product name “NISSEKI NEOPOLYMER 120”, softening point 120° C., hydroxyl value below 1 mgKOH/g), 40 parts of a terpene phenol resin, 30 parts of a terpene resin, 0.75 part by solid content of an isocyanate compound (available from Nippon Polyurethane Industry Co., Ltd., trade name “CORONATE L”), 1 part of an anti-aging agent, and toluene as a solvent were mixed with stirring to prepare a PSA composition a1 at 50% NV.

Herein, as the terpene phenol resin, two species, namely, trade name “YS POLYSTAR 5145” (softening point 145° C., hydroxyl value 100 mgKOH/g) and trade name “YS POLYSTAR T145” (softening point 145° C., hydroxyl value 60 mgKOH/g) both available from Yasuhara Chemical Co., Ltd., were used at a mass ratio of 1:1 in a combined amount of 40 parts. As for the terpene resin, was used product name “YS RESIN PX1150N” (softening point 115° C., hydroxyl value below 1 mgKOH/g) available from Yasuhara Chemical Co., Ltd. As the anti-aging agent, was used product name “IRGANOX CB612” available from BASF Corporation (a blend of product names “IRGAFOS 168” and “IRGANOX 565” both available from BASF Corporation at a mass ratio of 2:1).

### Examples a2 to a5

In place of the aromatic petroleum resin used in Example a1, were used, respectively, aromatic petroleum resins available from JX Nippon Oil & Energy Corporation under product names “NISSEKI NEOPOLYMER 130”, “NISSEKI NEOPOLYMER 140”, “NISSEKI NEOPOLYMER 150” and “NISSEKI NEOPOLYMER 170S”. The softening points and hydroxyl values of the respective aromatic petroleum resins are as shown in Table 1. Otherwise in the same manner as Example a1, PSA compositions a2 to a5 according to the respective examples were prepared.

### Examples a6 to a8

In place of the aromatic petroleum resin used in Example a1, were used, respectively, aromatic petroleum resins available from Tosoh Corporation under product names “PETCOAL 130”, “PETCOAL 140” and “PETCOAL 150”. The softening points and hydroxyl values of the respective aromatic petroleum resins are as shown in Table 1. Otherwise in the same manner as Example a1, PSA compositions a6 to a8 according to the respective examples were prepared.

### Examples a9 to a10

In place of the aromatic petroleum resin used in Example a1, to 100 parts of the base polymer, was used 20 parts (Ex. a9) or 50 parts (Ex. a10) of a coumarone-indene resin available from Nitto Chemical Co., Ltd., under product name “NTTTO RESIN COUMARONE V-120” (softening point 120° C., hydroxyl value 30 mgKOH/g). Otherwise in the same manner as Example a1, PSA compositions according to Examples a9 and a10 were prepared.

### Examples a11 to a12

In place of the aromatic petroleum resin used in Example a1, to 100 parts of the base polymer, was used 10 parts (Ex. a11) or 20 parts (Ex. a12) of an α-methylstyrene/styrene copolymer available from Mitsui Chemicals, Inc., under product name “FTR2140” (softening point 137° C., hydroxyl value below 1 mgKOH/g). Otherwise in the same manner as Example a1, PSA compositions according to Examples a11 and a12 were prepared.

### Example a13

In place of the aromatic petroleum resin used in Example a1, was used an aliphatic/aromatic copolymer-based petroleum resin available from Tosoh Corporation under product name “PETROTACK 130” (softening point 130° C., hydroxyl value below 1 mgKOH/g). The copolymer composition of the aliphatic/aromatic copolymer-based petroleum resin is 7% C5 fractions, 4% cyclopentadiene, 18% dicyclopentadiene, and 70% C9 fractions. Otherwise in the same manner as Example a1, a PSA composition according to Examples a13 was prepared.

### Example b1

In the same manner as Example a1 except that the aromatic petroleum resin was not used, a PSA composition according to Example b1 was prepared.

### Examples b2˜b4

In place of the aromatic petroleum resin used in Example a1, were used, respectively, a styrene resin (available from Yasuhara Chemical Co., Ltd., product name “YS RESIN SX”, softening point 100° C., hydroxyl value below 1 mgKOH/g), an α-methylstyrene/styrene copolymer (available from Rika Hercules Co., product name “PICCOTEX 120”, softening point 118° C., hydroxyl value below 1 mgKOH/g), and an aliphatic/aromatic copolymer-based petroleum resin (available from Tosoh Corporation, product name “PETROTACK 120”, softening point 119° C., hydroxyl value below 1 mgKOH/g). The copolymer composition of the aliphatic/aromatic copolymer-based petroleum resin (PETROTACK 120) is 14% C5 fractions, 6% cyclopentadiene, 19% dicyclopentadiene, and 61% C9 fractions. Otherwise in the same manner as Example a1, PSA compositions b2 to b4 according to the respective examples were prepared.

### [Fabrication and Evaluation of Double-Faced PSA Sheets]

Each of these PSA compositions a1 to a13 and b1 to b4 was applied to a first face of a 12 μm thick PET film (available from Toray Industries, Inc., trade name “LUMIRROR S10”) as a substrate and dried at 120° C. for 3 minutes to form a 64 μm thick PSA layer. To the PSA layer, was adhered a release liner treated with a silicone-based release agent. Subsequently, to the second face (opposite of the first face) of the PET film, in the same manner as the first face, a 64 μm thick PSA layer was formed and a release liner was adhered thereto. A double-faced PSA sheet corresponding to each PSA composition was thus fabricated.

With respect to the resulting double-faced PSA sheets, the results of the heat resistance test are shown in Table 1 to Table 3.

TABLE 1

| | | | | | al | a2 | a3 | a4 | a5 | a6 | a7 | a8 |
|---|---|---|---|---|---|---|---|---|---|---|---|---|
| | | | | Diblock | | | | | | | | |
| | | | St content (%) | fraction (%) | | | | | | | | |
| | | | 15 | 78 | 100 | 100 | 100 | 100 | 100 | 100 | 100 | 100 |
| | | | Softening point | OH value | | | | | | | | |
| Base polymer (parts) | | Quintac3520 | (° C.) | (mgKOH/g) | | | | | | | | |
| T_{H} | Aromatic petroleum resin | Nisseki Neopolymer 120 | 120 | <1 | 20 | — | — | — | — | — | — | — |
| (parts) | | Nisseki Neopolymer 130 | 130 | <1 | — | 20 | — | — | — | — | — | — |
| | | Nisseki Neopolymer 140 | 145 | <1 | — | — | 20 | — | — | — | — | — |
| | | Nisseki Neopolymer 150 | 155 | <1 | — | — | — | 20 | — | — | — | — |
| | | Nisseki Neopolymer 170S | 160 | <1 | — | — | — | — | 20 | — | — | — |
| | | Petcoal 130 | 125 | <1 | — | — | — | — | — | 20 | — | — |
| | | Petcoal 140 | 135 | <1 | — | — | — | — | — | — | 20 | — |
| | | Petcoal 150 | 140 | <1 | — | — | — | — | — | — | — | 20 |
| | Terpene phenol resin | S145 | 145 | 100 | 20 | 20 | 20 | 20 | 20 | 20 | 20 | 20 |
| | | T145 | 145 | 60 | 20 | 20 | 20 | 20 | 20 | 20 | 20 | 20 |
| T_{L} | Terpene resin | PX1150N | 115 | <1 | 30 | 30 | 30 | 30 | 30 | 30 | 30 | 30 |
| (parts) | | | | | | | | | | | | |

| | | | | | | | | | |
|---|---|---|---|---|---|---|---|---|---|
| Crosslinking agent (parts) | Coronate L | 0.75 | 0.75 | 0.75 | 0.75 | 0.75 | 0.75 | 0.75 | 0.75 |
| Heat resistance | (distance moved (mm) or time to falling off) | 1.6 | 0.7 | 0.6 | 0.6 | 0.6 | 1.9 | 1.0 | 0.7 |

TABLE 2

| | | | | | a9 | a10 | a11 | a12 | a13 |
|---|---|---|---|---|---|---|---|---|---|
| | | | | Diblock | | | | | |
| | | | St content (%) | fraction (%) | | | | | |
| | | | 15 | 78 | 100 | 100 | 100 | 100 | 100 |
| | | | Softening point | OH value | | | | | |
| Base polymer (parts) | | Quintac3520 | (° C.) | (mgKOH/g) | | | | | |
| T_{H} | Coumarone/indene resin | Coumarone V-120 | 120 | 30 | 20 | 50 | — | — | — |
| (parts) | Styrene resin | FTR2140 | 137 | <1 | — | — | 10 | 20 | — |
| | Copolymer-based petroleum resin | Petrotack130 | 130 | <1 | — | — | — | — | 20 |
| | Terpene phenol resin | S145 | 145 | 100 | 20 | 20 | 20 | 20 | 20 |
| | | T145 | 145 | 60 | 20 | 20 | 20 | 20 | 20 |
| T_{L} | Terpene resin | PX1150N | 115 | <1 | 30 | 30 | 30 | 30 | 30 |
| (parts) | | | | | | | | | |

| | | | | | | |
|---|---|---|---|---|---|---|
| Crosslinking agent (parts) | Coronate L | 0.75 | 0.75 | 0.75 | 0.75 | 0.75 |

| | | | | | |
|---|---|---|---|---|---|
| Heat resistance (mm or time to falling off) | 0.85 | 0.5 | 1.03 | 0.45 | 1.45 |

TABLE 3

| | | | | | b1 | b2 | b3 | b4 |
|---|---|---|---|---|---|---|---|---|
| | | | | Diblock | | | | |
| | | | St content (%) | fraction (%) | | | | |
| | | | 15 | 78 | | | | |
| | | | Softening point | OH value | | | | |
| Base polymer (parts) | | Quintac3520 | (° C.) | (mgKOH/g) | 100 | 100 | 100 | 100 |
| T_{H} | Terpene phenol resin | S145 | 145 | 100 | 20 | 20 | 20 | 20 |
| (parts) | | T145 | 145 | 60 | 20 | 20 | 20 | 20 |
| T_{L} | Styrene resin | YS Resin SX | 100 | <1 | — | 20 | — | — |
| (parts) | Copolymer-based petroleum resin | Piccotex120 | 118 | <1 | — | — | 20 | — |
| | | Petrotack120 | 119 | <1 | — | — | — | 20 |
| | Terpene resin | PX1150N | 115 | <1 | 30 | 30 | 30 | 30 |

| | | | | | |
|---|---|---|---|---|---|
| Crosslinking agent | Coronate L | 0.75 | 0.75 | 0.75 | 0.75 |

| | | | | |
|---|---|---|---|---|
| Heat resistance (distance moved (mm) or time to falling off) | 16 min | 35 min | 5 min | 44 min |

As shown in Tables 1 to 3, with respect to Example b1 (Table 3) not comprising a tackifier resin T_{HR1} (an aromatic ring-containing tackifier resin having a softening point of 120° C. or above while having a hydroxyl value of 30 mgKOH/g or lower), the measurement sample fell off in 16 minutes in the heat resistance test.

On the contrary to this, with respect to the PSA sheets of Examples a1 to a13 wherein 10 to 50 parts of various types of tackifier resin T_{HR1} had been added to the composition of Example b1, all resulted in significantly increased high temperature cohesive strength as compared to Example b1, without the measurement sample falling off even after one hour in the heat resistance test. Tackifier resins T_{HR1} used in Examples a1 to a13 are all essentially free of isoprene units, terpene structures and rosin structures.

On the other hand, with respect to Examples b2 to b4 in which 20 parts of a tackifier resin that did not qualify as a tackifier resin T_{HR1} was added, as compared to Examples a1 to a13, the effect of increasing the high temperature cohesive strength was clearly poorer (Examples b2, b4) or the high temperature cohesive strength decreased further (Example b3).

### Experiment 2

### Preparation of PSA Compositions

### Example c1

100 parts of a styrene-isoprene block copolymer (available from Zeon Corporation, product name “QUINTAC 3520”, 15% styrene content, 78% diblock fraction) as a base polymer, 40 parts of an aromatic petroleum resin (available from JX Nippon Oil & Energy Corporation, product name “NISSEKI NEOPOLYMER 150”, softening point 155° C., hydroxyl value below 1 mgKOH/g), 30 parts of a terpene resin, 0.75 part by solid content of an isocyanate compound (available from Nippon Polyurethane Industry Co., Ltd., trade name “CORONATE L”), 1 part of an anti-aging agent, and toluene as a solvent were mixed with stirring to prepare a PSA composition c1 at 50% NV.

Herein, as the terpene resin, was used product name “YS RESIN PX1150N” (softening point 115° C., hydroxyl value below 1 mgKOH/g) available from Yasuhara Chemical Co., Ltd. As the anti-aging agent, was used product name “IRGANOX CB612” available from BASF Corporation (a blend of product names “IRGAFOS 168” and “IRGANOX 565” both available from BASF Corporation at a mass ratio of 2:1).

### Example c2

In place of the styrene-isoprene block copolymer used in Example c1, was used a styrene-isoprene block copolymer available from JSR Corporation under trade name “SIS5505” (16% styrene content, 50% diblock fraction). Otherwise in the same manner as Example c1, a PSA composition according to Example c2 was prepared.

### Example c3

In place of the styrene-isoprene block copolymer used in Example c1, was used a styrene-isoprene block copolymer available from Kraton Polymers Japan under product name “D1113PT” (16% styrene content, 56% diblock fraction). Otherwise in the same manner as Example c1, a PSA composition according to Example c3 was prepared.

### Example c4

In place of the styrene-isoprene block copolymer used in Example c1, was used a styrene-isoprene block copolymer available from Kraton Polymers Japan under product name “D1119PT” (22% styrene content, 66% diblock fraction). Otherwise in the same manner as Example c1, a PSA composition according to Example c4 was prepared.

### [Fabrication and Evaluation of Double-Faced PSA Sheets]

Using the resulting PSA compositions c1 to c4, in the same manner as Experiment 1, double-faced PSA sheets were fabricated. With respect to these double-faced PSA sheets c1 to c4 and double-faced PSA sheets b1 and a4 fabricated in Experiment 1, the evaluation results of the heat resistance and ambient temperature peel strength are shown in Table 4.

TABLE 4

| | | | | | b1 | a4 | c1 | c2 | c3 | c4 |
|---|---|---|---|---|---|---|---|---|---|---|
| | | | | Diblock | | | | | | |
| | | | St content (%) | fraction (%) | | | | | | |
| | | Quintac3520 | 15 | 78 | 100 | 100 | 100 | — | — | — |
| | | IS5505 | 16 | 50 | — | — | — | 100 | — | — |
| | | D1113PT | 16 | 56 | — | — | — | — | 100 | — |
| Base polymer (parts) | | D1119PT | 22 | 66 | — | — | — | — | — | 100 |
| | | | Softening point | OH value | | | | | | |
| | | | (° C.) | (mgKOH/g) | | | | | | |
| T_{H} | Aromatic | Nisseki | 155 | <1 | — | 20 | 40 | 40 | 40 | 40 |
| (parts) | petroleum resin | Neopolymer 150 | | | | | | | | |
| | Terpene phenol resin | S145 | 145 | 100 | 20 | 20 | — | — | — | — |
| | | T145 | 145 | 60 | 20 | 20 | — | — | — | — |
| T_{L} | Terpene Resin | PX1150N | 115 | <1 | 30 | 30 | 30 | 30 | 30 | 30 |
| (parts) | | | | | | | | | | |

| | | | | | | | |
|---|---|---|---|---|---|---|---|
| Crosslinking agent (parts) | Coronate L | 0.75 | 0.75 | 0.75 | 0.75 | 0.75 | 0.75 |

| | | | | | | |
|---|---|---|---|---|---|---|
| Heat resistance (distance moved (mm) or time to falling off) | 16 [symbol] | 0.6 | 0.2 | 0.3 | 0.4 | 0.3 |
| Ambient temperature peel strength (N/20 mm) | 32.0 | 28.8 | 32.0 | 23.5 | 23.5 | 19.5 |

From comparison between Example b1 and Example c1 shown in Table 4, it has been confirmed that by replacing the tackifier resin T_{H} (a terpene phenol resin having a high hydroxyl value) that does not qualify as a tackifier resin T_{HR1} with a tackifier resin T_{HR1} (here, an aromatic petroleum resin), the high temperature cohesive strength is significantly increased. As compared to Example a4 in which the total amount of tackifier resin T_{H} was 60 parts to 100 parts of the base polymer, Example c1 in which the total amount of tackifier resin T_{H} was 55 parts or less exhibited even greater ambient temperature peel strength. The PSA sheet according to Example c1 was of high performance, combining ambient temperature peel strength as high as that of Example b1 and high temperature cohesive strength equally great as or greater than Example a4.

With respect to the PSA sheets of Examples c2 to c4 using the same tackifier resin T_{HR1} in the same amount while using different kinds of base polymer, all exhibited high temperature cohesive strength to levels equally excellent as Example c1. Among these, the PSA sheets of Examples c1 to c3 using, as the base polymer, a styrene-isoprene block copolymer having a styrene content below 20% exhibited greater ambient temperature peel strength (specifically, 20 N/20 mm or greater) as compared to Example c4. In particular, the PSA sheet of Example c1 using, as the base polymer, a styrene-isoprene block copolymer having a diblock fraction of 70% or higher exhibited particularly great ambient temperature peel strength (specifically 30 N/20 mm or greater).

### Experiment 3

### Preparation of PSA Compositions

### Example d1

100 parts of a styrene-isoprene block copolymer (available from Zeon Corporation, product name “QUINTAC 3520”, 15% styrene content, 78% diblock fraction) as a base polymer, 10 parts of an α-methylstyrene-styrene copolymer (available from Rika Hercules Co., product name “PICCOTEX 120”, softening point 118° C., hydroxyl value below 1 mgKOH/g), 40 parts of a terpene phenol resin, 30 parts of a terpene resin, 0.75 part by solid content of an isocyanate compound (available from Nippon Polyurethane Industry Co., Ltd., trade name “CORONATE L”), 1 part of an anti-aging agent, and toluene as a solvent were mixed with stirring to prepare a PSA composition d1 at 50% NV.

Herein, as the terpene phenol resin, two species, namely, trade name “YS POLYSTAR 5145” (softening point 145° C., hydroxyl value 100 mgKOH/g) and trade name “YS POLYSTAR T145” (softening point 145° C., hydroxyl value 60 mgKOH/g) both available from Yasuhara Chemical Co., Ltd., were used at a mass ratio of 1:1 in a combined amount of 40 parts. As for the terpene resin, was used product name “YS RESIN PX1150N” (softening point 115° C., hydroxyl value below 1 mgKOH/g) available from Yasuhara Chemical Co., Ltd. As the anti-aging agent, was used product name “IRGANOX CB612” available from BASF Corporation (a blend of product names “IRGAFOS 168” and “IRGANOX 565” both available from BASF Corporation at a mass ratio of 2:1).

### Example d2

In the same manner as Example d1 except that the amount of the α-methylstyrene/styrene copolymer (softening point 118° C.) used was modified to 40 parts, a PSA composition according to Example d2 was prepared.

### Example d3

In place of the aromatic petroleum resin used in Example d1, was used 30 parts of an α-methylstyrene/styrene copolymer (product name “FTR2140”, softening point 137° C., hydroxyl value below 1 mgKOH/g) available from Mitsui Chemicals, Inc. Otherwise in the same manner as Example d1, a PSA composition according to Example d3 was prepared.

### Example d4

In the same manner as Example d3 except that the amount of the α-methylstyrene/styrene copolymer (softening point 137° C.) was modified to 40 parts, a PSA composition according to Example d4 was prepared.

### [Fabrication and Evaluation of Double-Faced PSA Sheets]

Using the resulting PSA compositions d1 to d4, in the same manner as Experiment 1, double-faced PSA sheets were fabricated. With respect to these double-faced PSA sheets d1 to d4 and double-faced PSA sheets b1, b3, a11 and a12 fabricated in Experiment 1, the evaluation results of the heat resistance, ambient temperature peel strength and low temperature peel strength are shown in Table 5. In Table 5, “—” in a field under the heat resistance indicates that it was not evaluated.

TABLE 5

| | | | | | b1 | d1 | b3 | d2 | a11 | a12 | d3 | d4 |
|---|---|---|---|---|---|---|---|---|---|---|---|---|
| | | | St content | Diblock | | | | | | | | |
| | | | (%) | fraction (%) | | | | | | | | |
| | | | 15 | 78 | 100 | 100 | 100 | 100 | 100 | 100 | 100 | 100 |
| | | | Softening | | | | | | | | | |
| | | | point | OH value | | | | | | | | |
| Base polymer (parts) | | Quintac3520 | (° C.) | (mgKOH/g) | | | | | | | | |
| T_{H} | Styrene resin | FTR2140 | 137 | <1 | — | — | — | — | 10 | 20 | 30 | 40 |
| (parts) | Terpene | S145 | 145 | 100 | 20 | 20 | 20 | 20 | 20 | 20 | 20 | 20 |
| | phenol resin | T145 | 145 | 60 | 20 | 20 | 20 | 20 | 20 | 20 | 20 | 20 |
| T_{L} | Styrene resin | Piccotex120 | 118 | <1 | — | 10 | 20 | 40 | — | — | — | — |
| (parts) | Terpene resin | PX1150N | 115 | <1 | 30 | 30 | 30 | 30 | 30 | 30 | 30 | 30 |

| | | | | | | | | | |
|---|---|---|---|---|---|---|---|---|---|
| Crosslinking agent (parts) | Cornonate L | 0.75 | 0.75 | 0.75 | 0.75 | 0.75 | 0.75 | 0.75 | 0.75 |

| | | | | | | | | |
|---|---|---|---|---|---|---|---|---|
| Heat resistance (distance moved (mm) or time to falling off) | 16 min | — | 5 min | — | 1.03 | 0.45 | — | — |
| Ambient temperature peel strength (N/20 mm) | 32.0 | 32.0 | 32.0 | 31.0 | 32.0 | 31.5 | 31.5 | 32.0 |
| Low temperature peel strength (N/20 mm) | 28.3 | 27.3 | 20.0 | 11.5 | 20.0 | 19.0 | 16.8 | 16.2 |

Based on the results of Examples a11, a12, d3 and d4 shown in Table 5, it has been confirmed that when the amount of tackifier resin T_{HR1} used relative to 100 parts of the base polymer is in a range of at least 10 parts up to 40 parts, the PSA sheet can realize ambient temperature peel strength similar to that of Example b1 and heat resistance (high temperature cohesive strength) significantly better than that of Example b1 at the same time. Although some decrease in the low temperature peel strength was observed when the amount of tackifier resin T_{HR1} used was 30 parts or more, the extent of the decrease was smaller as compared to the cases (Examples d1, b3, d2) using a tackifier resin that did not qualify as a tackifier resin T_{HR1}.

### Experiment 4

### Example e1

### Preparation of PSA Composition

100 parts of a styrene-isoprene block copolymer (available from Zeon Corporation, product name “QUINTAC 3520”, 15% styrene content, 78% diblock fraction) as a base polymer, 40 parts of a terpene phenol resin, 30 parts of a terpene resin, 0.75 part by solid content of an isocyanate compound (available from Nippon Polyurethane Industry Co., Ltd., trade name “CORONATE L”), 3 parts of an anti-aging agent, and toluene as a solvent were mixed with stirring to prepare a PSA composition at 50% NV.

Herein, as the terpene phenol resin, two species, namely, trade name “YS POLYSTAR 5145” (softening point 145° C., hydroxyl value 100 mgKOH/g) and trade name “YS POLYSTAR T145” (softening point 145° C., hydroxyl value 60 mgKOH/g) both available from Yasuhara Chemical Co., Ltd., were used at a mass ratio of 1:1 in a combined amount of 40 parts. As for the terpene resin, was used product name “YS RESIN PX1150N” (softening point 115° C., hydroxyl value below 1 mgKOH/g) available from Yasuhara Chemical Co., Ltd. As the anti-aging agent, was used product name “IRGANOX CB612” available from BASF Corporation (a blend of product names “IRGAFOS 168” and “IRGANOX 565” both available from BASF Corporation at a mass ratio of 2:1).

### [Fabrication of Double-Faced PSA Sheets]

Was obtained a release liner comprising high-grade paper laminated with a 25 μm thick PE layer on top of which a release treatment with a silicone-based release agent had been given. To the treated release surface of the release liner, the resulting PSA composition was applied and allowed to dry to form a PSA layer. The resulting PSA layer was transferred onto the first face of a substrate. Similarly, a PSA layer was formed also on the second face of the substrate. As the substrate, was used a PET-based non-woven fabric having a grammage of 14 g/m², a thickness of 40 μm and a bulk density of 0.35 g/cm³. A double-faced PSA sheet (total thickness 140 μm) according to Example e1 was thus fabricated.

### Example e2

In the same manner as Example e1 except that a 100% hemp pulp non-woven fabric having a grammage of 23 g/m², a thickness of 76 μm and a bulk density of 0.30 g/cm³ was used as the substrate, a double-faced PSA sheet according to Example e2 was fabricated.

### Example e3

In the same manner as Example e1 except that a pulp-based non-woven fabric having a grammage of 14 g/m², a thickness of 42 μm and a bulk density of 0.33 g/cm³ was used as the substrate, a double-faced PSA sheet according to Example e3 was fabricated.

### Example e4

In the same manner as Example e1 except that a 100% hemp pulp non-woven fabric having a grammage of 14 g/m², a thickness of 50 μm and a bulk density of 0.28 g/cm³ was used as the substrate, a double-faced PSA sheet according to Example e4 was fabricated.

### Example e5

In the same manner as Example e1 except that a pulp-based non-woven fabric having a grammage of 14 g/m², a thickness of 27 μm and a bulk density of 0.52 g/cm³ was used as the substrate, a double-faced PSA sheet according to Example e5 was fabricated.

### Example e6

In the same manner as Example e1 except that a 100% pulp non-woven fabric having a grammage of 14 g/m², a thickness of 28 μm and a bulk density of 0.50 g/cm³ was used as the substrate, a double-faced PSA sheet according to Example e6 was fabricated.

### Example e7

100 parts of a styrene-isoprene block copolymer (available from Zeon Corporation, product name “QUINTAC 3520”, 15% styrene content, 78% diblock fraction) as a base polymer, 20 parts of an aromatic petroleum resin (available from JX Nippon Oil & Energy Corporation, product name “NISSEKI NEOPOLYMER 150”, softening point 155° C., hydroxyl value below 1 mgKOH/g), 40 parts of a terpene phenol resin, 30 parts of a terpene resin, 0.75 part by solid content of an isocyanate compound (available from Nippon Polyurethane Industry Co., Ltd., trade name “CORONATE L”), 3 parts of an anti-aging agent, and toluene as a solvent were mixed with stirring to prepare a PSA composition at 50% NV. The terpene phenol resin, terpene resin and anti-aging agent used were the same as those used in Example e1. In the same manner as Example e3 except that this PSA composition was used, a double-faced PSA sheet according to Example e7 was fabricated.

### Example e8

In the same manner as Example e1 except that a 12 μm thick PET film was used as the substrate, a double-faced PSA sheet according to Example e8 was fabricated.

### [Repulsion Resistance Test]

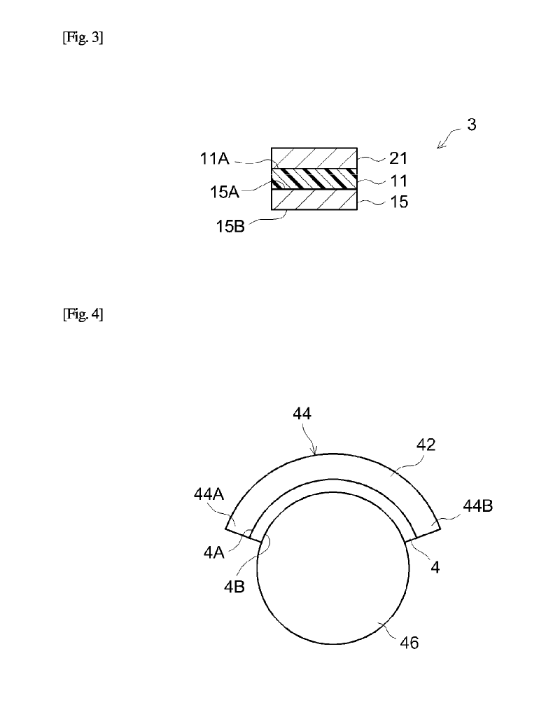

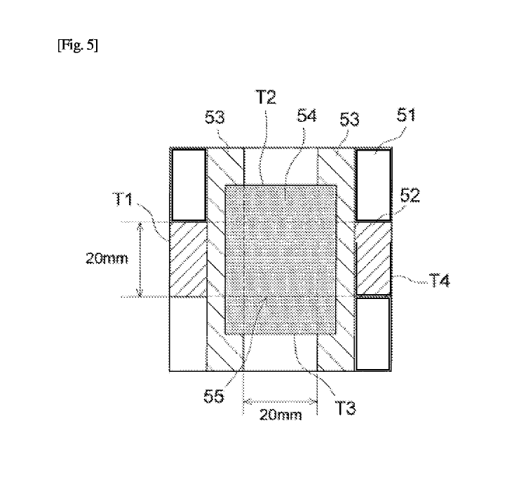

Using an aluminum cylinder of 24 mm diameter as an adherend, the repulsion resistance of the double-faced PSA sheet according to each example was evaluated. In particular, as shown in FIG. 4, the first adhesive face 4A of double-faced PSA sheet 4 was adhered to and backed with 300 μm thick PET film 42. The backed double-faced PSA sheet 4 was cut to 10 mm wide by 40 mm long to prepare a test piece 44. In an environment at 23° C. and 50% RH, the second adhesive face 4B of test piece 44 was pressure-bonded with a 2 kg roller moved back and forth once to the adherend, such that the length direction of test piece 44 was in the circumferential direction of adherend (aluminum cylinder) 46. Adherend 46 was washed with ethanol in advance and used. After the resultant was left in an environment at 70° C. and 80% RH for 12 hours, it was observed if the two edges 44A and 44B of the length direction of test piece 44 peeled off to float above the surface of adherend 46. When some floating was observed, the floating distance (the distance from the surface of adherend 46 to the level of the floating test piece 44) was measured. When both the edges floated, the average value of the floating distances of the two edges was recorded as the floating distance of the test piece. The results are shown in Table 6 and Table 7.

TABLE 6

| Example | | el | e2 | e3 | e4 | e5 | e6 |
|---|---|---|---|---|---|---|---|
| PSA (parts) | Quintac3520 | 100 | 100 | 100 | 100 | 100 | 100 |
| | YS Polystar S145 | 20 | 20 | 20 | 20 | 20 | 20 |
| | YS Polystar T145 | 20 | 20 | 20 | 20 | 20 | 20 |
| | PX1150N | 30 | 30 | 30 | 30 | 30 | 30 |
| | Coronate L | 0.75 | 0.75 | 0.75 | 0.75 | 0.75 | 0.75 |
| Non-woven fabric | Material | PET | Hemp pulp | Pulp | Hemp pulp | Pulp | Pulp |
| | Grammage (g/m²) | 14 | 23 | 14 | 14 | 14 | 14 |
| | Thickness (μm) | 40 | 76 | 42 | 50 | 27 | 28 |
| | Bulk density (g/cm³) | 0.35 | 0.3 | 0.33 | 0.28 | 0.52 | 0.5 |

| | | | | | | |
|---|---|---|---|---|---|---|
| Repulsion resistance floating distance (mm) | 1.8 | 2.3 | 1.6 | 1.9 | 2.8 | 2.6 |

TABLE 7

| | | Example | | |
|---|---|---|---|---|
| | | e3 | e7 | e8 |
| PSA (parts) | Quintac3520 | 100 | 100 | 100 |
| | Neopolymer150 | — | 20 | — |
| | YS Polystar S145 | 20 | 20 | 20 |
| | YS Polystar T145 | 20 | 20 | 20 |
| | PX1150N | 30 | 30 | 30 |
| | Coronate L | 0.75 | 0.75 | 0.75 |
| Non-woven fabric | Material | Pulp | Pulp | —* |
| | Grammage (g/m²) | 14 | 14 | |
| | Thickness (μm) | 42 | 42 | |
| | Bulk density (g/cm³) | 0.33 | 0.33 | |

| | | | |
|---|---|---|---|
| Repulsion resistance floating distance | 1.6 | 1.0 | 1.0 |
| (mm) | | | |

*12 μm thick PET film was used instead of a non-woven fabric

As shown in Table 6, with respect to the double-faced PSA sheets according to Examples e1 to e6 using non-woven fabrics as the substrate, all exhibited good repulsion resistance. Among these, with the double-faced PSA sheets according to Examples e1, e3 and e4 each using a non-woven fabric having a grammage, a thickness and a bulk density in the prescribed ranges (specifically, a grammage of 14 g/m², a thickness of 40 μm to 50 μm, a bulk density of 0.28 g/cm³ to 0.35 g/cm³), greater results were obtained as indicated each by the floating distance of 2 mm or smaller in the repulsion resistance test. In particular, the double-faced PSA sheet according to Example e3 exhibited the most excellent repulsion resistance among Examples e1 to e6. Moreover, as shown in Table 7, the double-faced PSA sheet according to Example e7 using a rubber-based PSA comprising a tackifier resin having a softening point of 120° C. or above while having a hydroxyl value of 30 mgKOH/g or lower exhibited repulsion resistance that favorably compares with Example e8 using a PET film as the substrate. From these results, it can be said that by using a rubber-based PSA containing a tackifier resin having a softening point of 120° C. or above while having a hydroxyl value of 30 mgKOH/g or lower in combination with a non-woven fabric substrate, it is possible to obtain a PSA sheet exhibiting excellent repulsion resistance. Although not specifically shown, when the double-faced PSA sheets according to Examples e1 to e8 were measured for the peel strength (ambient temperature peel strength) to SUS by the method described earlier, all were found to have an adhesive strength of 28 N/20 mm or greater. With respect to Example e7, when the heat resistance test was performed by the method described above, the PSA sheet adhered on the adherend retained without falling for more than one hour.

### Experiment 5

### Example f1

### Preparation of PSA Composition

100 parts of a styrene-isoprene block copolymer (available from Zeon Corporation, product name “QUINTAC 3520”, 15% styrene content, 78% diblock fraction) as a base polymer, 40 parts of a terpene phenol resin, 30 parts of a terpene resin, 20 parts of an aromatic petroleum resin (available from JX Nippon Oil & Energy Corporation, product name “NISSEKI NEOPOLYMER 150”, softening point 155° C., hydroxyl value below 1 mgKOH/g), 1.00 part by solid content of an isocyanate compound (available from Nippon Polyurethane Industry Co., Ltd., trade name “CORONATE L”), 3 parts of an anti-aging agent, and toluene as a solvent were mixed with stirring to 48% NV. To 100 parts of non-volatiles in this mixture, 5 parts of conductive particles (available form Fukuda Metal Foil and Powder Co., Ltd., trade name “Ni123”, nickel filler, average particle diameter 11 μm) was added and mixed to prepare a PSA composition according to the present example.

Herein, as the terpene phenol resin, two species, namely, trade name “YS POLYSTAR 5145” (softening point 145° C., hydroxyl value 100 mgKOH/g) and trade name “YS POLYSTAR T145” (softening point 145° C., hydroxyl value 60 mgKOH/g) both available from Yasuhara Chemical Co., Ltd., were used at a mass ratio of 1:1 in a combined amount of 40 parts. As for the terpene resin, was used product name “YS RESIN PX1150N” (softening point 115° C., hydroxyl value below 1 mgKOH/g) available from Yasuhara Chemical Co., Ltd. As the anti-aging agent, was used product name “IRGANOX CB612” available from BASF Corporation (a blend of product names “IRGAFOS 168” and “IRGANOX 565” both available from BASF Corporation at a mass ratio of 2:1).

### [Fabrication of Single-Faced PSA Sheets]

A PET release liner sheet (available from Mitsubishi Polyester Film, trade name “MFR #38”, 38 μm thick) having a face treated with a silicone-based release agent was obtained. To the treated release surface of the release liner, the resulting PSA composition was applied and allowed to dry at 100° C. for three minutes to form a PSA layer. The resulting PSA layer was transferred onto the first face of a substrate. As the substrate, electrolytic copper foil (available from Fukuda Metal Foil and Powder Co., Ltd., trade name “CF-T8G-UN-35”, 35 μm thick) was used Aconductive single-faced PSA sheet having a 20 μm thick PSA layer on one face was thus fabricated.

### Example f2

In the same manner as Example f1 except that the amount of conductive particles added was modified to 35 parts to 100 parts of non-volatiles in the mixture, a conductive single-faced PSA sheet according to Example f2 was fabricated.

### [180° Peel Strength]

The single-faced PSA sheet according to each example was cut to 20 mm wide by 100 mm long to prepare a measurement sample. In an environment at 23° C. and 60% RH, the adhesive face of the measurement sample was pressure-bonded to an adherend surface with a 2 kg roller moved back and forth once. The resultant was left in the same environment for 30 minutes. Subsequently, using a universal tensile and compression tester (product name “Tensile and Compression Testing Machine, TG-1kN” available from Minebea Co., Ltd.), based on JIS Z0237, the 180° peel strength (N/20 mm-width) was measured at a tensile speed of 300 mm/min and a peel angle of 180°. For the adherend, a stainless steel plate (SUS304 plate) was used. The results are shown in Table 8.

### [Measurement of Resistance]

The single-faced PSA sheet according to each example was cut to 30 mm wide by 40 mm long to prepare a measurement sample. As shown in FIG. 5, on a glass plate (soda lime glass) 51, a 20 mm wide copper foil strip (rolled copper foil, 35 μm thick) 52 was placed. Further on top of it, an insulating tape strip 53 was overlaid so that it orthogonally intersects the length direction of copper foil 52. Two sheets of insulating tape 53 were obtained and the two sheets were placed in parallel to each other at a distance of 20 mm. A measurement sample 54 was pressure-bonded so that it overlapped copper foil 52 and insulating tape 53. Measurement sample 54 (a single-faced PSA sheet) was adhered so that the adhesive face of its PSA layer came in contact with the surface of copper foil 52. Measurement sample 54 and copper foil 52 are in contact over an adherered area 55 (the square region surrounded by the broken line placed centrally in FIG. 5) (contact surface area 4 cm²). The pressure-bonding was carried out at a pressure of 5.0 N/cm with a hand-held roller (30 mm wide) in an environment at ambient temperature. In FIG. 5, the vertical direction corresponds to the length direction of measurement sample 54. After it was left in the ambient temperature environment for 15 minutes, terminals of an ammeter (available from Kikusui Electronics Corp., DC power supply “PMC18-S”) were connected to an edge (the portion marked as T1 in FIG. 5) of copper foil 52 and an edge (the portion marked as T2 in FIG. 5) of the substrate (electrolytic copper foil) of measurement sample 54. Terminals of a digital multimeter (available from Iwatsu Test Instruments Corporation, trade name “VOAC7521A”) were connected to an edge (the portion marked as T3 in FIG. 5) of the substrate (electrolytic copper foil) of measurement sample 54 and an edge (the portion marked as T4 in FIG. 5) of copper foil 52. A current measured at 0.1 A by the ammeter was passed through and the potential difference was measured with the digital multimeter. From the potential difference obtained, the resistance value was determined by the Ohm's law. The results are shown in Table 8.

TABLE 8

| | | Example | |
|---|---|---|---|
| | | f1 | f2 |
| PSA (parts) | Quintac3520 | 100 | 100 |
| | Neopolymer150 | 20 | 20 |
| | YS Polystar S145 | 20 | 20 |
| | YS Polystar T145 | 20 | 20 |
| | PX1150N | 30 | 30 |
| | Coronate L | 1.00 | 1.00 |
| | Conductive particles | 5* | 35* |

| | | |
|---|---|---|
| Substrate | Electrolytic | Electrolytic |
| | copper foil | copper foil |
| 180° Peel strength (N/20 mm) | 26.8 | 26.5 |
| Resistance value (Ω) | 0.05 | 0.04 |

*in parts to 100 parts of PSA non-volatiles excluding conductive particles

As shown in Table 8, the PSA sheets according to Examples f1 and f2 each comprising conductive particles in the PSA layer showed great adhesive strength (specifically, an adhesive strength of 25 N/20 mm or greater) while exhibiting a resistance value as low as or lower than 0.112. From these results, it is evident that inclusion of conductive particles in the PSA disclosed herein allows formation of a PSA sheet that is highly adhesive while having excellent conductivity.

Although specific embodiments of the present invention have been described in detail above, these are merely for illustrations and do not limit the scope of the claims. The art according to the claims includes various modifications and changes made to the specific embodiments illustrated above.

What is claimed is:

1. A pressure-sensitive adhesive composition comprising a base polymer and a tackifier resin, wherein
the base polymer is a block copolymer of a monovinyl-substituted aromatic compound and a conjugated diene compound,
the tackifier resin comprises a tackifier resin T_{H} having a softening point of 120° C. or above, and
the tackifier resin T_{H} comprises a tackifier resin T_{HR1} having an aromatic ring and having a hydroxyl value of 30 mgKOH/g or lower.

2. The pressure-sensitive adhesive composition according to claim 1, wherein the tackifier resin T_{HR1} is at least one selected from the group consisting of coumarone-indene resins, aromatic petroleum resins, aliphatic/aromatic copolymer-based petroleum resins and styrene-based resins.

3. The pressure-sensitive adhesive composition according to claim 1, wherein the tackifier resin further comprises a tackifier resin T_{L} having a softening point below 120° C.

4. The pressure-sensitive adhesive composition according to claim 1, wherein the base polymer is a styrene-based block copolymer.

5. The pressure-sensitive adhesive composition according to claim 4, wherein the styrene content of the styrene-based block copolymer is 20% by mass or lower.

6. The pressure-sensitive adhesive composition according to claim 4, wherein the tackifier resin T_{HR1} content is in a range of 0.1 to 10 parts by mass relative to 1 part by mass of styrene in the styrene-based block copolymer.

7. The pressure-sensitive adhesive composition according to claim 1, wherein the base polymer has a diblock fraction of 60% by mass or greater.

8. The pressure-sensitive adhesive composition according to claim 1, further comprising conductive particles.

9. The pressure-sensitive adhesive composition according to claim 8, wherein the conductive particle content is 0.01 part by mass to 100 parts by mass relative to 100 parts by mass of all non-volatiles in the pressure-sensitive adhesive composition excluding the conductive particles.

10. A pressure-sensitive adhesive sheet comprising a pressure-sensitive adhesive formed from the pressure-sensitive adhesive composition according to claim 1.

11. The pressure-sensitive adhesive composition according to claim 2, wherein the tackifier resin further comprises a tackifier resin T_{L} having a softening point below 120° C.

12. The pressure-sensitive adhesive composition according to claim 2, wherein the base polymer is a styrene-based block copolymer.

13. The pressure-sensitive adhesive composition according to claim 12, wherein the styrene content of the styrene-based block copolymer is 20% by mass or lower.

14. The pressure-sensitive adhesive composition according to claim 12, wherein the tackifier resin T_{HR1} content is in a range of 0.1 to 10 parts by mass relative to 1 part by mass of styrene in the styrene-based block copolymer.

15. The pressure-sensitive adhesive composition according to claim 2, wherein the base polymer has a diblock fraction of 60% by mass or greater.

16. The pressure-sensitive adhesive composition according to claim 2, further comprising conductive particles.

17. The pressure-sensitive adhesive composition according to claim 16, wherein the conductive particle content is 0.01 part by mass to 100 parts by mass relative to 100 parts by mass of all non-volatiles in the pressure-sensitive adhesive composition excluding the conductive particles.

18. A pressure-sensitive adhesive sheet comprising a pressure-sensitive adhesive formed from the pressure-sensitive adhesive composition according to claim 2.

19. The pressure-sensitive adhesive composition according to claim 3, wherein the base polymer is a styrene-based block copolymer.

20. The pressure-sensitive adhesive composition according to claim 19, wherein the styrene content of the styrene-based block copolymer is 20% by mass or lower.
